(19) United States
(12) Patent Application Publication
(10) Pub. No.: US 2026/0332484 A1
(43) Pub. Date: Oct. 22, 2026

(54) CROSS-PLATFORM MULTI-NODE NETWORK VISUALIZATION SYSTEM FOR NARRATIVE INTELLIGENCE

(71) Applicant: SocialTrendly, Inc. d/b/a Blackbird.AI, Rochester, NY (US)

(72) Inventors: Paul Burkard, Kure Beach, NC (US); Naushad UzZaman, Bellmore, NY (US); Roberta Duffield, Dudley (GB); Wasim Khaled, Pittsford, NY (US)

(73) Assignee: SocialTrendly, Inc. d/b/a Blackbird.AI, Rochester, NY (US)

(21) Appl. No.: 19/644,370

(22) Filed: Apr. 10, 2026

Related U.S. Application Data
(60) Provisional application No. 63/789,543, filed on Apr. 16, 2025.

(51) Int. Cl. H04L 41/14

(52) U.S. Cl. CPC H04L 41/145

(57) ABSTRACT

Systems and methods for generating multi-node network graphs are provided. A computer-implemented method can include accessing communication data across a set of digital communication platforms. The computer-implemented method can also include processing the communication data to extract a first content element and a second content element having different content types. The computer-implemented method can also include identifying a contextual relationship between the first content element and the second content element. The contextual relationship can include one or more characteristics shared between the first content element and the second content element. The computer-implemented method can also include generating a multi-node network graph that includes a set of nodes and edges. In some instances, the set of nodes includes a first node that represents the first content element and a second node that represents the second content element, in which the first and second nodes are connected by a corresponding edge.

### CROSS-REFERENCES TO RELATED APPLICATIONS

This application claims benefit to U.S. Provisional Application No. 63/789,543, filed Apr. 16, 2025 and entitled “CROSS-PLATFORM MULTI-NODE NETWORK VISUALIZATION SYSTEM FOR NARRATIVE INTELLIGENCE”, which is hereby incorporated by reference, in its entirety and for all purposes.

### FIELD

The present disclosure relates generally to generating network graphs based on communication data accessed from digital-communication platforms. In one example, the systems and methods described herein may include techniques for generating multi-node network graphs representing multi-modal data across multiple digital communication platforms.

### SUMMARY

Disclosed embodiments may provide systems and methods for generating multi-node network graphs representing multi-modal data across multiple digital communication platforms. A computer-implemented method can include accessing communication data across a set of digital communication platforms. In some instances, the communication data includes multimodal data. The computer-implemented method can also include processing the communication data to extract a first content element and a second content element. In some instances, a first content element is associated with a first content type and a second content element is associated with a second content type, in which the first content type is different the second content type. The computer-implemented method can also include identifying a contextual relationship between the first content element and the second content element. The contextual relationship can include one or more characteristics shared between the first content element and the second content element. The computer-implemented method can also include generating a multi-node network graph that includes a set of nodes and edges. In some instances, the set of nodes includes a first node that represents the first content element and a second node that represents the second content element, and wherein the first node and the second node are connected by a corresponding edge. The computer-implemented method can also include outputting the multi-node network graph.

In an embodiment, a system comprises one or more processors and memory including instructions that, as a result of being executed by the one or more processors, cause the system to perform the processes described herein. In another embodiment, a non-transitory computer-readable storage medium stores thereon executable instructions that, as a result of being executed by one or more processors of a computer system, cause the computer system to perform the processes described herein.

Various embodiments of the disclosure are discussed in detail below. While specific implementations are discussed, it should be understood that this is done for illustration purposes only. A person skilled in the relevant art will recognize that other components and configurations can be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the embodiments. Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which can be exhibited by some embodiments and not by others.

The terms used in this specification generally have their ordinary meanings in the art, within the context of the disclosure, and in the specific context where each term is used. Alternative language and synonyms can be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles can be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Illustrative embodiments are described in detail below with reference to the following figures.

FIG. 1 illustrates an example configuration of a multi-node network graph representing multi-modal data across multiple digital communication platforms, according to some embodiments.

FIG. 2 illustrates a computing environment of a network-visualization system for generating multi-node network graphs, according to some embodiments.

FIG. 3 illustrates an example screenshot of a multi-node network graph representing narratives and communication platforms, according to some embodiments.

FIG. 4 illustrates an example screenshot of a multi-node network graph representing users and cohorts, according to some embodiments.

FIG. 5 illustrates an example screenshot of a multi-node network graph representing users, narratives, and entities, according to some embodiments.

FIG. 6 illustrates an example screenshot of another multi-node network graph representing users and cohorts, according to some embodiments.

FIG. 7 shows an illustrative example of a process for generating multi-node network graphs representing multi-modal data across multiple digital communication platforms, in accordance with some embodiments.

FIG. 8 shows a computing system architecture including various components in electrical communication with each other using a connection in accordance with various embodiments.

In the appended figures, similar components and/or features can have the same reference label. Further, various components of the same type can be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Misinformation on the internet has become a pervasive and concerning issue, presenting a complex challenge that spans various domains. As used herein, misinformation refers to false or misleading information disseminated through online or offline platforms, often with the intent to deceive or manipulate audiences. This misinformation can take many forms, including fake news articles, fabricated images or videos, misleading social media posts, and deceptive websites. The misinformation can spread rapidly across digital networks, amplified by the viral nature of social media and the ease of sharing information online. The consequences of misinformation are far-reaching, ranging from undermining trust in credible sources of information to fueling societal divisions, influencing public opinion, and even inciting real-world harm. To combat misinformation, various techniques were developed to analyze large volumes of data (e.g., documents) and identify actionable insights. For example, existing techniques analyze unstructured data to identify “narratives”, in which a narrative includes semantic content (e.g., text, images, videos, or metadata) that collectively convey a theme, perspective, or storyline represented by the corresponding data or content. The narrative can reflect certain user engagement patterns, algorithmic amplification, and content dissemination patterns, at which misinformation and security threats can be detected. In some instances, a narrative additionally includes a “narrative definition,” in which the narrative definition includes text data that identifies one or more characteristics of the semantic content of the corresponding narrative.

Different types of data being generated from digital communication platforms (e.g., social media networks) can be processed to identify possible misinformation and any users that propagate such misinformation. Digital communication platforms typically analyze user-to-user interaction networks, such as “friend” or “follower” graphs in which a user is connected to various other users. However, these approaches struggle to capture other ways information can propagate. For example, existing “friend” graphs cannot identify the manner in which narratives spread across multiple platforms, particularly when direct interaction data—such as shares or likes—is unavailable. This limitation is especially problematic as mis-, dis-, and mal-information campaigns increasingly operate across multiple digital ecosystems without obvious interaction signals such as “likes” or “shares”, thereby making it difficult to trace the origins and evolution of misinformation and network security threats. Moreover, existing techniques often lack advanced graph features such as comprehensive time-series visualizations and metadata overlays that can be leveraged for detecting coordinated or malicious activities.

Another challenge facing social media network analyses is that the existing techniques largely remain siloed within a single communication platform. As a result, the graphs generated from the existing techniques do not provide a comprehensive view of how certain information can propagate across different communication platforms. Other existing solutions that attempt to aggregate data across digital communication platforms are limited in integrating various content types and often fail in providing actionable insights. For example, existing social media monitoring tools (e.g., Brandwatch, Meltwater) can generally provide aggregate statistics (mentions, sentiment trends) but are limited in cross-platform unification. In another example, some existing systems (Botometer, BotSlayer from OSoMe) provide advanced bot detection but remain platform-specific. In yet another example, some solutions aggregate data from multiple data sources (e.g., Talkwalker), but these solutions typically do not unify data in a multi-node manner with time-series narrative analysis.

In addition, the existing techniques do not treat “entities” that include content elements such as URLs, images, videos, and hashtags or “channels” that include specialized online communities as primary analytical nodes. This omission prevents effective cross-platform linkage and weakens the ability to track narratives through diverse content modalities. Without these capabilities, identifying and countering complex information campaigns remains a significant challenge.

To address the above-noted deficiencies, the present techniques provide systems and methods for network visualization for understanding narrative intelligence in social media and digital communication platforms. A network-visualization system is configured to generate a multi-node network graph that integrates multiple content types. The content types can include users, entities (e.g., any shareable content units such as URLs, domains, hashtags, images, videos, recurring phrases or named entities), narratives, and channels (e.g., specialized online communities such as subreddits, Telegram channels, or Facebook groups), which can be integrated into a single, dynamic multi-node network graph structure. The multi-node network graph can enable cross-platform analysis of shared content, interactions, and relationships. In some instances, by overlaying rich metadata (e.g., bot scores, cohort classifications, partisanship indicators) and leveraging time-series visualizations, the multimodal graph can be used to reveal how narratives, including potential mis-, dis-, or mal-information campaigns, propagate and evolve across different digital communication platforms.

In some instances, the narratives, enrichments, and entities are extracted using machine-learning models, and their integration as high-priority graph data in the multi-node network graph empowers identification of emerging threats, track cross-platform amplification, and more effectively counter narrative-based attacks across any data sources and content modalities (e.g., text, images, videos).

Accordingly, the present techniques are directed to a significant improvement over existing techniques that analyze data in digital communication platforms. For example, the present techniques provide cross-platform unification of actors and content units, which is limited in existing techniques. In particular, existing techniques focus heavily on user-to-user interactions, making it practically impossible to seamlessly track how shared content flows between different communication platforms. The present techniques address such challenges by unifying “actors” (users or groups) and “content units” (entities, narratives) in one multi-node network graph, even if the platforms do not directly interface with each other.

In another example, the present techniques provide robust narrative intelligence for multi-modal data. Social conversations are no longer limited to text, but now include images, videos, memes, and/or links. By representing these content modalities as “entities” in the graph structure, the network-visualization system uncovers relationships that might remain invisible in a purely text-based approach. In yet another example, the present techniques facilitate real-time and historical cross-platform tracking. Specifically, the time-series-based visualization of the present techniques reveals exactly how a particular narrative originates in one platform (e.g., Telegram channel), spreads to other platforms (e.g., Twitter/X, Reddit), and evolves over time. Such features can be used to detect and respond to fast-moving disinformation or malicious information campaigns.

Moreover, by overlaying enrichments like bot scores, cohort classifications, and partisanship data on each node (actor, content unit, channel), the network-visualization system highlights suspicious behavior, clarifies the role of state actors or partisan groups, and simplifies the process of attributing malicious activity. The unified graph generated by the network-visualization system can thus provide a holistic view of content creators, amplifiers, communities (channels), and the narratives themselves, making it easy to identify patterns, high-risk clusters, or high-volume channels within a single graphical user interface. As a result, by combining multi-node graph analysis with real-time data, countermeasures can be rapidly developed to address disinformation, phishing, or other malicious attacks, as well as identifying positive opportunities to enhance brand reputation.

The present techniques can be utilized for various types of implementations. The network-visualization system can serve as a powerful tool for monitoring and analyzing various forms of digital discourse across multiple domains. For instance, in corporate brand monitoring, the network-visualization system can track brand-related narratives across diverse online channels, including social media platforms, news websites, and discussion forums. By visualizing patterns in user-generated content, sentiment shifts, and the spread of misinformation, companies can proactively manage their brand reputation, identify emerging public relations crises, and detect coordinated smear campaigns. Similarly, in the context of election integrity, the network-visualization system can be deployed to identify and analyze real-time attempts at foreign influence or the emergence of partisan echo chambers. By mapping interactions, content dissemination patterns, and bot activity, election-monitoring agencies can pinpoint disinformation campaigns designed to manipulate voter sentiment or suppress turnout. Additionally, the network-visualization system plays a crucial role in combating health-related misinformation by cross-platform tracking of medical or pandemic-related rumors. For example, during a public health crisis, it can identify the rapid spread of false claims regarding vaccine efficacy or unproven treatments, enabling health authorities to intervene with accurate information before misinformation becomes widespread. Lastly, in the financial sector, the network-visualization system can be utilized to detect fraudulent activities, such as pump-and-dump schemes, by linking user narratives and discussions about certain stocks across different social platforms. By analyzing spikes in stock-related mentions, detecting coordinated promotional efforts, and identifying sudden shifts in sentiment, regulators and financial analysts can uncover market manipulation schemes before they cause significant financial harm to investors.

### I. TECHNIQUES FOR IMPLEMENTING MULTI-NODE NETWORK VISUALIZATION SYSTEM FOR NARRATIVE INTELLIGENCE

As described herein, the present techniques provide a network-visualization system that can be configured to integrate data objects having different content types into a single, dynamic multi-node network graph. For example, the network-visualization system collects social media data and other digital communications across multiple digital-communication platforms (e.g., Twitter/X, Facebook, Telegram, Reddit), multiple languages, and multiple modalities. The network-visualization system can identify one or more characteristics (users, narratives, channels, entities) associated with the collected data and generate nodes to represent such characteristics. The network-visualization system can then construct a multi-node network graph in which edges represent relationships or interactions (e.g., shared links, topic mentions, likes, reposts) between the nodes. The length of the edges can indicate how closely the two nodes are contextually aligned with each other. In some instances, the network-visualization system can incorporate time-series-based visualization to observe how these relationships and narratives evolve over time and across platforms.

The network-visualization system can be configured to process multimodal data accessed from a wide range of data sources. For example, the network-visualization system access text data from text-based platforms (e.g., Twitter, Reddit), image data from image-centric platforms (e.g., Instagram), video data from video-sharing platforms (e.g., TikTok), and so on. Data collected from multiple content modalities (text, images, videos, or combined content) can be processed and incorporated into the multi-node network graph by the network-visualization system. Additionally or alternatively, the network-visualization system can also apply metadata enrichments, such as bot detection scores, partisanship measures, or cohort classifications, to highlight influential or suspicious actors and their roles in amplifying content. In addition, the network-visualization system can facilitate cross-platform narrative discovery, enabling analysts to see when seemingly disparate groups of users are effectively discussing or amplifying the same narrative or entities/concepts.

In some instances, the network-visualization system can be implemented as a software or web-based analytics platform, incorporating a modular architecture that integrates several components for efficient data processing and visualization. The network-visualization system's data collection pipelines can leverage APIs, web scraping techniques, and streaming data ingestion frameworks (e.g., Apache Kafka, Flink, Spark Streaming) to continuously retrieve structured and unstructured data from various data sources, including social media platforms, news sites, and discussion forums. Once ingested, the data can be preprocessed using natural language processing (NLP) techniques, including tokenization, named entity recognition (NER), sentiment analysis, and topic modeling, to extract meaningful insights.

For efficient graph storage and querying, the network-visualization system can employ distributed graph databases such as Neo4j, ArangoDB, or TigerGraph, which support high-performance graph-traversal queries and real-time graph analytics. The network-visualization system can enable dynamic and interactive exploration of network structures, community detection, and clustering. To enhance the analytical capabilities, the network-visualization system may incorporate machine learning-based entity linking and cross-referencing with external data sources such as domain-specific databases or fact-checking repositories.

To handle large-scale graph computations, the network-visualization system can integrate hardware acceleration through GPUs (using CUDA-based frameworks like RAPIDS cuGraph) or TPUs for deep learning-based graph analysis. This enables faster processing of complex graph operations such as centrality calculations, link prediction, and anomaly detection. Additionally, the network-visualization system can be containerized using Docker and Kubernetes, facilitating flexible deployment across on-premise infrastructure, cloud-based environments (AWS, Azure, GCP), or hybrid computing environments.

The network-visualization system can also be configured to seamlessly integrate with existing social media monitoring solutions, using RESTful APIs, GraphQL endpoints, or message brokers like RabbitMQ. This ensures interoperability with third-party analytics tools, SIEM platforms, or enterprise data lakes. In an alternative embodiment, the network-visualization system can function as a standalone solution, offering an end-to-end analytics workflow with customizable dashboards, automated alerting mechanisms, and role-based access control (RBAC) to ensure secure and scalable operations.

Additionally or alternatively, instead of a property multi-node network graph, RDF-based knowledge graphs can be used for storing relationships and entity metadata. RDF-based knowledge graphs are configured to leverage the Resource Description Framework (RDF), a standard model for data interchange on the web. Unlike property graphs, which use labeled nodes and edges with key-value properties, RDF represents data as a collection of subject-predicate-object triples, thereby forming a directed graph structure. The RDF-based knowledge graphs can be used for semantic reasoning, interoperability, and flexible data integration across different domains. By using ontologies and schema vocabularies (e.g., OWL, RDFS, SKOS), RDF graphs can also encode hierarchical relationships, infer implicit connections, and facilitate advanced reasoning over linked data.

### A. Overview

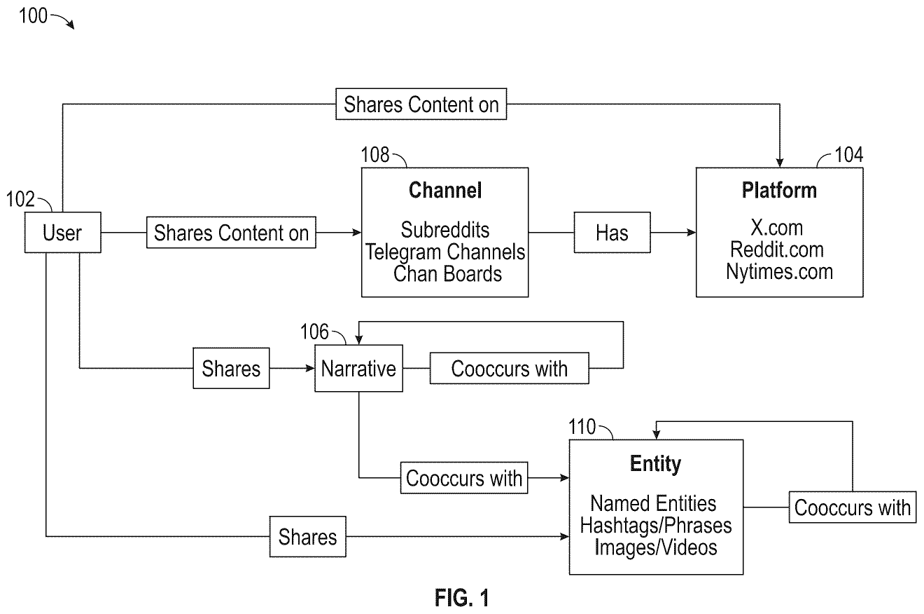

FIG. 1 illustrates an example configuration of a multi-node network graph 100 representing multi-modal data across multiple digital communication platforms, according to some embodiments. As shown in FIG. 1, the multi-node network graph can include nodes that represent platforms, narratives, channels, and entities, which allow advanced connectivity analysis not found in typical user-only networks. Node Types can include the following types of content elements. Platforms can correspond to an online domain where content is shared, e.g. x.com, reddit.com, nytimes.com, etc. Narratives can refer to granular claims made in the content, such as opinions or statements of fact (e.g. “The 2020 election was stolen” or “The Kansas City Chiefs won the super bowl). Broader topics can be captured as nodes as well and narratives can be organized in a hierarchical structure with subnarratives. Channels can refer to a subsection of a platform for posting around a specific community, topic, etc. Examples potentially include subreddits, Telegram channels, chan boards, etc. Entities can refer to the general idea of discrete content units or concepts that can be shared. This can include but is not necessarily limited to named entities, multiword phrases, hashtags, domains, URLs, images, videos, gifs, etc. Users can refer to the authors of content on a platform.

The multi-node network graph structure 100 includes a plurality of nodes. A node can represent various types of content accessed from digital communication platforms. For example, a node can include a user node 102, a platform node 104, a narrative node 106, a channel node 108, and an entity node 110. These types of nodes 102-110 allow for a more advanced representation of relationships beyond typical user-only networks. By incorporating multiple node types, the network-visualization system captures complex interactions between content, sources, and dissemination pathways, providing a richer analytical framework for detecting misinformation.

As an illustrative example, a user node 102 can represent the users who generated or propagated content across one or more digital communication platforms. A platform node 104 can include digital communication platforms (also referred to as “platforms”) that represent online domains where content is shared and disseminated. Examples of platforms can include, but are not limited to social media sites, news websites, and discussion forums such as x.com, reddit.com, and nytimes.com. By treating platforms as distinct nodes, the network-visualization system models how different online spaces contribute to the spread of information and influence discourse.

A narrative node 106 can represent narratives that include granular claims made within content, encompassing opinions, statements of fact, or widely discussed assertions. As described herein, a narrative can include semantic content (e.g., text, images, videos, or metadata) that collectively convey a theme, perspective, or storyline represented by the corresponding data or content. Examples of narratives can include statements such as “The 2020 election was stolen” or “The Kansas City Chiefs won the Super Bowl.” In some instances, in addition to individual narratives, broader topics can be collectively represented as the narrative node 106, with narratives organized in a hierarchical structure that includes subnarratives. Such node structure allows for nuanced analysis of how ideas evolve, fragment, or gain traction within digital ecosystems.

A channel node 108 can represent communication channels (also referred to as “channels”) that include subsections of platforms dedicated to specific communities, topics, or discussions. The channels may include subreddits, Telegram channels, or chan boards, which serve as focal points for targeted information dissemination and audience engagement. By modeling channels as distinct nodes, the network-visualization system captures how information propagates within specific channels and how different communities interact with shared content. An entity node 110 can represent entities that include discrete content units or concepts that can be shared across platforms. Examples of entities can include named entities, single word, multiword phrases, hashtags, domains, URLs, images, videos, and GIFs. By incorporating entities into the multi-node network graph, the network-visualization system can track the movement and transformation of content across different online environments, offering insights into how narratives spread and evolve. By mapping user interactions with narratives, platforms, and channels, the network-visualization system can analyze influence patterns, detect coordinated activity, and uncover the dynamics of information dissemination.

Various types of contextual relationships can also be indicated in the multi-node network graph. For example, the channel node 108 can be connected to the platform node 104, which may indicate the channel represented in the channel node 108 is present or operated by the platform represented by the platform node 104. In another example, the user node 102 can be connected to the channel node 108 and the platform node 104, which may indicate that the user shares content on both of the corresponding channels and platforms. In yet another example, the user node 102 can be connected to the narrative node 106 and the entity node 110, which may indicate that the user shares content that is being represented by the corresponding narratives and entities. The narrative node 106 can be connected to other narrative nodes and the entity node 110, which may indicate that the narrative represented by the narrative node 106 include semantic content that substantially aligns or concurs with corresponding entities or other narratives. Similarly, the entity node 110 can be connected to the narrative node 106 based on the shared semantic characteristics. The contextual relationships are for illustrative purposes only, and other types of contextual relationships and combinations thereof can be contemplated by a person skilled in the art.

In some instances, time-series tracking of the multi-node network graph can be provided. The dynamic layering of temporal data on top of the graph can enable real-time updates and historical replay of data amplification. Stated differently, time-series tracking of a multi-node network graph can be implemented by overlaying temporal data onto the existing graph structure, allowing for both real-time monitoring and historical analysis of data flow. In some instances, time-series tracking allows dynamic updates where new data points continuously generate nodes, adjust node attributes (e.g., bot scores), and modify the contextual relationships between nodes, in order to provide immediate insights into system behavior. For instance, temporal layering can visualize how a particular narrative (e.g., the narrative node 106) can be increasingly connected through different user nodes and channel nodes, thus indicating possible cohort formation and abnormal activity patterns. Further, historical replay functionality allows users to review past states of the multi-node network graph, facilitating forensic analysis or trend detection of certain narratives and user cohorts.

In some instances, narrative intelligence-focused enrichments can be provided. Combining network visualizations with narrative intelligence-focused enrichments such as bot scores and cohort scores can yield high-value insights into coordinated or malicious information campaigns. Additionally or alternatively, a simplified network graph without advanced narrative intelligence signals (e.g., bot detection, cohort identification) can be generated to reduce computational costs and allow local-device implementation, which still retains narrative/entity nodes and time-series visualization.

By generating the multi-node network graph across different types of content objects, cross-platform cohesion can be realized as the content objects do not conform specifically to a particular digital communication platform. The ability to cluster users across different social networks based on shared narratives can significantly advance existing social media analytics capabilities.

Various operations can be performed to utilize information from the multi-node network graphs. For example, the multi-node network graph may help detect the presence of misinformation or network threats in the digital communication platforms, allowing for proactive measures to mitigate security risks and ensure information integrity. The mitigation measures can include deactivating the accounts associated with the narratives classified as misinformation, dropping or otherwise blocking network packets transmitted from the IP addresses of the accounts associated with certain narratives, or deleting content generated by such accounts. For the positive content elements, different types of operations can be performed by the digital communication platform such as widely distributing the content associated with narratives classified as being positive and accurate (for example).

### B. Computing Environment

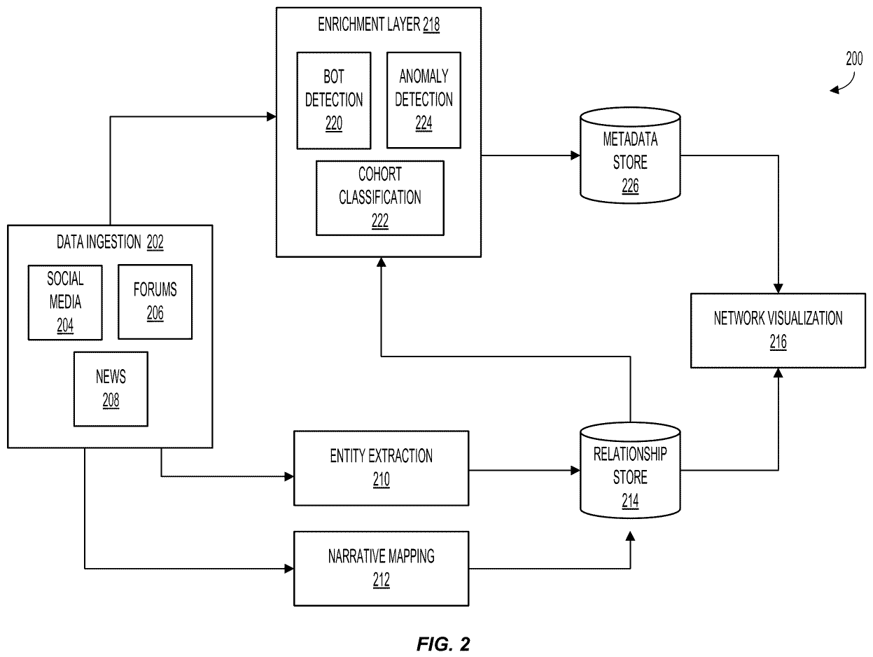

FIG. 2 illustrates a computing environment of a network-visualization system 200 for generating multi-node network graphs, according to some embodiments. The network-visualization system is thus not restricted to a single platform or content type; it can process data from text-heavy forums (e.g., Twitter), image-based sharing (e.g., Instagram), short-form video (e.g., TikTok), and any future modality. As a result, the multi-node network graph can capture contextual relationships between various data elements of communication data.

### 1. Data Collection & Normalization

The network-visualization system 200 ingests data from various platforms, normalizing user profiles, posts, and metadata (time, source, etc.). NLP techniques can be used to identify topics, entities, and narratives in the text or media content.

Initially, a data ingestion module 202 of the network-visualization system 200 ingests communication data from multiple platforms and channels, including social media networks 204, forums 206, and news websites 208. For example, the communication data can include structured and unstructured data, such user profiles, posts, comments, timestamps, and associated metadata (e.g., device type, geolocation, platform source) retrieved from one of the social media networks 204. In some instances, the communication data can be multimodal data that includes combinations of data having multiple data types, such as text, images, audio, video, and sensor readings. In some instances, the multimodal data can also include certain data types such as metadata, document markup language (e.g., JSON), URLs, executable does, and so on.

To standardize this heterogeneous data, the data ingestion module 202 can apply various normalization techniques to the communication data to resolve format inconsistencies, deduplicate records, and align attributes into a common schema. For example, usernames from different communication platforms may be mapped to a single user identity using heuristics or machine-learning-based entity resolution methods. Additionally, the data ingestion module 202 can convert timestamps of the communication from different time zones into a unified format, ensuring consistency across data points when performing time-series analysis. The normalization process facilitates downstream analysis by transforming disparate data representations into a consistent, structured dataset that can be effectively processed for generating the multi-node network graph.

### 2. Content Element Extraction

In some instances, once the communication data is normalized, the network-visualization system 200 can apply natural language processing (NLP) to the communication data and the preprocessed data items to extract a plurality of content elements that represent the communication data. In some instances, a content element identifies one or more characteristics that represent the communication data. Examples of the content elements can include, but are not limited to, users, channels, platforms, entities, and narratives.

In some instances, there are different techniques to identify the narratives or entities representing the communication data. To extract the content elements, a Named entity recognition (NER) module 210 of the network-visualization system 200 can apply various NER techniques to the communication data to identify people, organizations, locations, and other key entities within the communication data. For example, NER techniques can include the use of machine-learning techniques trained on labeled datasets to recognize entity types based on surrounding words and linguistic structures. Examples of NER techniques can include, but are not limited to, rule-based approaches that rely on predefined dictionaries and regular expressions, statistical models such as Conditional Random Fields (CRF), and deep learning-based methods like Bidirectional LSTMs with CRF layers or transformer-based models such as BERT and spaCy's entity recognition module.

In some instances, a narrative mapping module 212 of the network-visualization system 200 can extract narratives from the communication data. The NER techniques or narrative extraction can implement one or more content-discovery machine-learning models to generate the corresponding content elements (e.g., narratives, entities). Examples of the content-discovery machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the content-discovery machine-learning model can include, but are not limited to, genetic algorithms, backpropagation, reinforcement learning, decision trees, linear classification, artificial neural networks, anomaly detection, and such. In yet other examples, the content-discovery machine-learning model may include regression analysis, dimensionality reduction, metalearning, reinforcement learning, deep learning, and other such algorithms and/or methods.

In some instances, the content-discovery machine-learning model is a transformer model (e.g., a large-language model (LLM)) obtained from a models database. In some instances, the machine-learning model is trained using self-supervised learning based on a large corpus of text data, such that the content-discovery machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

An illustrative example process of training and deploying the transformer model (e.g., a GPT model) is as follows. For the training dataset (e.g., the previous input data and content elements), the masked self-attention process can begin by transforming each word in a given training text sequence into three vectors: the query (Q), key (K), and value (V) vectors. A Q vector can represent what information the token is querying about other tokens, a K vector can represent the token's context used to establish relationships with other tokens, and a V vector can represent the token's actual content/information. In some instances, the Q, K, and V vectors can be obtained by multiplying the input embeddings by learned weight matrices.

An attention score for a particular word can be calculated by taking the dot product of the Q vector of the word with the K vectors of all words in the sequence, thereby producing a score that reflects the relevance of each word pair. The attention scores can be used as weights, which can be applied to the Q, K, V vectors to generate a weighted contextual representation of the particular word. Stated differently, the attention score can be used as a weight to transform the Q, K, V vectors of a given word to generate a weighted, computed representation that can be used to train the corresponding transformer model.

In some instances, a mask can be applied to the self-attention mechanism such that a contextual representation of a given token is determined without weights associated with future tokens. As a result, an attention score of a particular token can be adjusted to disregard information from tokens that have not been processed yet. The attention scores can then be scaled by the square root of the key dimension to stabilize training and passed through a softmax function to convert the attention scores into probabilities, ensuring they sum to one. The transformation can identify the most relevant words while downplaying less important ones. The resulting attention weights can then be used to compute a weighted sum of the V vectors, thus producing a new contextual representation for each token that incorporates contextual information from the entire sequence.

To enhance the model's ability to capture various types of relationships, self-attention mechanisms can use multiple sets of Q, K, and V matrices, also referred to as multi-head attention. Each set, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

The transformer model can then be trained using autoregressive language modeling to predict a subsequent token of a target sequence based on the contextual representations that represent the preceding tokens. For each position in the sequence, the transformer model accesses a contextual representation of the token, which was generated using masked self-attention mechanism. The transformer model can then output a probability distribution over a vocabulary for the subsequent token, conditioned on the sequence of preceding tokens. The subsequent token can then be compared with a corresponding token of the training data to calculate a loss. The loss measures the discrepancy between the predicted token and the actual token, providing a signal for the model to adjust its parameters. The loss can then be used to adjust parameters of the transformer model, including the parameters of the Q, K, V matrices.

Through iterative training iterations, the transformer model learns to minimize this loss across the entire training dataset. This process ensures that the model generates coherent and contextually appropriate sequences by leveraging the learned representations and adjusting its parameters based on the training data.

In some instances, the network-visualization system can construct one or more prompts that can be submitted with the communication data to enhance and increase the accuracy of the content elements. As used herein, the term “prompt” can refer to an input sequence generated to direct a corresponding machine-learning model's generation process towards producing a target output. In some instances, a filtering prompt includes a sequence of text tokens in a specific format (e.g., text, XML data, JSON data) and language (e.g., English, Korean).

In some instances, the prompts are machine-generated prompts that are generated by one or more computer systems without user intervention. For example, the one or more filtering prompts can be constructed using prompt engineering. Prompt engineering can include techniques for designing and implementing prompts within a machine-learning system to generate target responses or actions. In some instances, prompt engineering leverages a combination of linguistic approaches, machine-learning algorithms, and domain knowledge to formulate prompts that elicit specific outputs from a corresponding machine-learning model. The prompt engineering process typically begins with an analysis of a target or a problem domain, followed by the formulation of prompts tailored to achieve the desired results.

As an illustrative example for optimizing prompts, a prompt P can be defined as a sequence of tokens, tailored to elicit specific responses from a machine-learning model. The model employs an objective function O(P, R) to evaluate the quality of generated responses R given the prompt P. The responses R can be generated based on a machine-learning language model LM processing the prompt P (e.g., the function LM(P)). Different types of objective functions can be selected depending on the task and targeted output. For example, an objective function can correspond to a text summarization technique using ROUGE scores. In another example, the objective function can correspond to a translation quality assessment technique using BLEU scores. In some instances, optimization techniques like gradient descent or evolutionary algorithms are used to iteratively refine the prompt P to maximize O(P, R), to facilitate the model to consistently produce accurate, relevant, and contextually appropriate outputs (e.g., the content elements). For example, the optimal prompt P* can be determined based on maximizing the objective function O:

P*=argmax O(P, LM(P)) Equation (1)

Through the iterative refinement process, prompt engineering enhances the corresponding model's performance across various natural language processing tasks, such as generating the content elements that are contextually relevant to the communication data.

In some instances, prompt engineering includes a selection of input formats and structures. The input-format selection can include determining the syntactic and semantic characteristics of the prompts that will effectively guide the machine-learning model towards the desired outputs. In some instances, linguistics and computational linguistics can be used to select input formats that are semantically meaningful and contextually relevant. The input-format selection can ensure that the prompts effectively communicate the desired tasks or questions to the machine-learning model. The prompt engineering process can also include an optimization of prompt parameters. The optimization can include fine-tuning various parameters such as prompt length, complexity, and specificity to enhance the machine-learning model's performance on targeted tasks. Different prompt formulations and configurations such as grid search or Bayesian optimization can be implemented to optimize the prompt parameters. Additionally or alternatively, techniques such as zero-shot learning or few-shot learning can be implemented to fine-tune the machine-learning models to generalize from limited prompt examples.

The prompt engineering process can be configured based on an underlying machine-learning model architecture and training data. For example, an appropriate pre-trained machine-learning model architecture (e.g., GPT, BERT, or Transformer) that aligns with the task requirements and available computational resources can be identified for a given task. In some instances, the machine-learning model can be fine-tuned on task-specific data to further improve probability of outputting target responses. Various types of training datasets can be used to train and fine-tune the machine-learning model, so as to enable the machine-learning model to understand and generate responses to prompts accurately.

In some instances, an iterative process of designing, testing, and optimizing prompts is implemented based on feedback from initial model outputs. This iterative approach allows for continuous improvement and refinement of the prompt engineering process, ultimately leading to better-performing machine-learning models. Additionally or alternatively, ongoing monitoring and evaluation of model performance can be used to identify any errors or biases introduced by the prompts and prompt engineering process, in which the feedback data can be generated based on the evaluation. The feedback data can be used to further adjust the parameters of the machine-learning models, such that the machine-learning models can be updated to improve accuracy in generating the target responses.

The network-visualization system can apply the trained and fine-tuned machine-learning model to the communication data to generate the content elements. To begin the deployment process, the network-visualization system can tokenize the merged data into a sequence of text tokens. For example, the merged data can be tokenized to provide the following sequence: [“You”, “are”, “an”, “assistant”, “tasked”, . . . .]. In some instances, the machine-learning model uses Byte Pair Encoding (BPE) techniques to further split a single token (e.g., “in”, “sufficient”).

The network-visualization system can assign each token with a particular index value in the vocabulary (e.g., “assistant” =E[5]). Then, the network-visualization system can convert each token into a vector representation (e.g., an embedding) based on a pre-trained embedding matrix. For example, for a vocabulary size V and embedding dimension dᵢ, the embedding matrix E is of size V×d, in which the vector eᵢ can be generated for the text token tᵢ based on using the index value looking at a corresponding row of embedding matrix E.

E:eᵢ=E[tᵢ] Equation (2)

The network-visualization system can then process the sequence of embeddings (e₁, e₂, e₃, . . . eₙ) that represent the sequence of tokens by adding positional encodings to account for the order of tokens. In some instances, positional encodings are vectors added to each token embedding to inject information about the position of tokens in the sequence. A matrix X can be formed that includes the sequence of position-encoded vectors.

For the matrix X, the network-visualization system can then determine a contextual representation for each position-encoded vector of the matrix X. In particular, for each position-encoded vector, the network-visualization system can generate a set of Q, K, V vectors for the position-encoded vector. As described herein, a Q vector can represent what information the token is querying about other tokens, a K vector can represent the token's context used to establish relationships with other tokens, and a V vector can represent the token's actual content/information.

In some instances, to enhance the model's ability to capture various types of relationships, the position-encoded vector can be represented by multiple sets of Q, K, and V matrices (i.e., multi-head attention). Each set of Q, K, V vectors, or head, can learn different aspects of the relationships within the input data. The outputs from these heads can be concatenated and linearly transformed to form the final self-attention output. This multi-head approach allows the transformer models to simultaneously consider different features and interactions, enriching its understanding of the input sequence.

An attention score can be calculated for the set of Q, K, V vectors as follows:

Attention (Q,K,V)=softmax((QK^{T})/√(dₖ))V -Equation (3)

The (QK^{T})/√(dₖ) can be used to compute the raw attention scores, in which dₖ is the dimensionality of the key vectors. Then, the softmax function is applied to the raw attention score to normalize it into a probability distribution. The network-visualization system can apply the attention score to a V vector of the corresponding set of Q, K, V vectors, such that the weighted Q, K, V vectors can be used as the contextual representation of the position-encoded vector of matrix X. In the instances in which multi-head attention is used, the multiple sets of weighted Q, K, V vectors can be concatenated and linearly transformed using a weight matrix W^{O} to generate the contextual representation of the position-encoded vector. The above process can be iterated through other position-encoded vectors of matrix X to generate a set of contextual representations associated with the merged data.

The network-visualization system can then apply the machine-learning model to the set of contextual representations to generate the content elements. In particular, the machine-learning model can process the set of contextual representations to predict each token of the content elements, in which the output tokens can correspond to the content elements.

In some instances, images and videos ingested from platforms can be analyzed via image/video recognition techniques (e.g., detecting certain logos or themes, convolutional neural networks), enabling richer cross-platform linking than text-only approaches. Examples of image and video recognition techniques include object detection models like YOLO (You Only Look Once) and Faster R-CNN, which identify and classify objects within images in real time. Image classification models such as ResNet and EfficientNet can categorize entire images based on learned patterns, while optical character recognition (OCR) systems like Tesseract or Google Vision API extract text from images and videos for further analysis. For video processing, action recognition models like SlowFast Networks analyze motion patterns to detect activities, and facial recognition techniques such as FaceNet or DeepFace enable identity verification across frames.

The content elements are extracted, the network-visualization system 200 can store the content elements in a relationship database 214. The relationship database 214 can include relational databases that include traditional SQL-based systems such as MySQL, PostgreSQL, and Microsoft SQL Server, which use structured tables and predefined schemas to organize data efficiently. As an alternative to relational databases, non-relational databases like MongoDB or Cassandra can be used for handling unstructured or semi-structured content elements, offering schema flexibility and high availability. In cases where flexibility in data modeling is required, hybrid databases such as NewSQL solutions offer both relational consistency and NoSQL-like scalability. Additionally, graph databases like Neo4j or Amazon Neptune can be integrated alongside relational databases to represent complex relationships between content elements, enabling more advanced queries for connected data.

### 3. Graph Construction

A network-visualization module 216 of the network-visualization system 200 can access the plurality of content elements from the relationship database 214. Then, the network-visualization module 216 can generate a multi-node network graph based on the plurality of content elements. As previously described in FIG. 1, each content element (e.g., user, narrative, channel, domain) or any combination of content elements is represented as a node in the graph.

The network-visualization module 216 can further generate edges of the multi-node network graph that connect two or more nodes. In some instances, edges capture various types of contextual relationships between the content elements: (i) user-to-narrative (e.g., user posted, shared narrative); (ii) user-to-user (e.g., direct interactions between users); and (iii) user-to-channel (e.g., user posts in that channel). The contextual relationships identify how content elements can interact with each other, even if they are directed to different content types and retrieved from various digital communication platforms. The length of the edges can indicate how closely the two nodes are contextually aligned with each other. For example, edges with shorter distance indicate that an author of a user node published a narrative of a narrative node on several occasions, whereas edges with longer distance may indicate that a second user of a second user node has only shared the narrative of the narrative node once. Alternatively, each edge can represent a single post or document in the system. For instance, a post by User X sharing Narrative Y would generate a single edge between the User X and Narrative Y nodes. In this formulation, there can be multiple edges between a given pair of nodes. When a spatial graph layout algorithm is applied to the visualization network, such as a force-directed graph layout, then nodes with more edges will be positioned closer to one another in space in the graph. The contextual relationships are for illustrative purposes only, and other types of contextual relationships and combinations thereof can be contemplated by a person skilled in the art.

Additionally or alternatively, the network-visualization module 216 can utilize advanced indexing techniques (e.g., property graphs) for efficient querying and data retrieval from the multi-node network graph. For example, adjacency list indexing can be used to store direct relationships between nodes, enabling fast traversal in graph queries. Inverted indexing, commonly used in text search engines, can be applied to efficiently retrieve nodes or edges based on attributes or metadata. Hash-based indexing techniques, such as those used in key-value stores, can optimize lookups by mapping unique node identifiers to their storage locations. B-tree and LSM-tree indexing, commonly found in relational and NoSQL databases, can improve range queries and write-heavy workloads, respectively.

### 4. Enrichment Layer

In some instances, an enrichment layer 218 of the network-visualization system 200 can further process the communication data and/or the content elements to generate enrichment data associated with the multi-node network graph. The network-visualization module 216 can then generate the multi-node network graph and the enrichment data, in which the enrichment data can be overlaid over the multi-node network graph to identify different characteristics associated with the users, narratives, and entities. In some instances, the enrichment data can include bot scores, cohort classifiers, and anomaly classifications. Additionally or alternatively, the network-visualization system 200 may bypass the enrichment layer 218. In the alternative embodiment, a simplified multi-node network graph can be generated without advanced narrative intelligence signals (e.g., bot detection, cohort identification) but still retaining the nodes and time-series visualization, to reduce the use computational resources, increase computing speed, and allow local-device implementation.

The enrichment layer 218 can perform bot detection 220 by processing content elements to classify one or more users as automated agents. For example, the enrichment layer 218 can generate a bot score for each user element, in which the bot score indicates a probability or likelihood that the user corresponds to an automated agent. In some instances, a bot-detection machine learning model can be used to process the content elements to generate the bot scores for each content element. Examples of the bot-detection machine-learning model (including sub-models of the multimodal model) can include algorithms such as k-means clustering algorithms, fuzzy c-means (FCM) algorithms, expectation-maximization (EM) algorithms, hierarchical clustering algorithms, and density-based spatial clustering of applications with noise (DBSCAN) algorithms, in which the algorithms can be trained using unsupervised learning. Other examples of the bot-detection machine-learning model can include, but are not limited to, genetic algorithms, backpropagation, reinforcement learning, decision trees, linear classification, artificial neural networks, anomaly detection, and such. In yet other examples, the bot-detection machine-learning model may include regression analysis, dimensionality reduction, metalearning, reinforcement learning, deep learning, and other such algorithms and/or methods.

In some instances, the bot-detection machine-learning model is a transformer model (e.g., a large-language model (LLM)) obtained from a models database. In some instances, the machine-learning model is trained using self-supervised learning based on a large corpus of text data, such that the bot-detection machine-learning model can generate narratives. In addition to training the model, various prompts can be used for prompt engineering of the machine-learning model for generating the narratives. Examples of the machine-learning model can include, but are not limited to, BERT model, Claude LLM, Falcon 40B, Ernie, GPT-3, GPT-3.5, GPT 4, Lamda, and Llama.

The enrichment layer 218 can also perform cohort identification and assignment 222 of the content elements. For example, a particular user element can be assigned with a cohort classifier such as “State Actor,” “Influencer,” or “Partisan Group.” As described herein, cohorts can include groups of users who share common characteristics, behaviors, or interactions over a defined period. The cohorts can be formed based on demographic attributes, shared interests, engagement patterns, or connectivity within the communication platforms. For example, a cohort may include users who shared and authored similar content, or follow the same influencers.

The enrichment layer 218 can also perform anomaly detection 224 within the content elements. The anomaly detection 224 can generate an anomaly classification that is predictive of whether certain content elements (e.g., user elements) or contextual relationship between the content elements (e.g., some users sharing content corresponding to a particular narrative) that indicate anomalous online operations. For example, the anomaly classification can correspond to a label that classifies whether the content or user engaged in potentially anomalous operations that may result in potential echo chambers.

In some instances, an output of a particular enrichment data layer operation can be used as input for another enrichment data layer operation. As an illustrative example, once the bot scores are generated using the bot detection 220, the anomaly detection 224 can process the bot scores to determine whether certain narratives generated by user elements indicate one or more anomalous operations. Additionally or alternatively, the enrichment layer 218 can utilize rule-based methods bot detection 220, cohort assignment 222, anomaly detection 224, or other suspicious network activity. Rule-based analysis can involve applying predefined rules or heuristics to automatically process and evaluate user-generated content or interactions to generate the bot scores or assign cohort classifiers. The rule-based methods can be advantageous in deployments in which computing resources are constrained and/or network availability is sporadic.

Once the bot scores, cohort classifiers, and the anomaly classifications are generated, the enrichment metadata can then be stored in a metadata database 226. The network-visualization module 216 can then access the metadata database 226 to overlay or incorporate the enrichment data into the multi-node network graph.

### 5. Time-series and Visualization

The present techniques can also facilitate visualization of how edges and node clusters evolve over time, pinpointing moments of significant narrative spread or user engagement. As described herein, the dynamic layering of temporal data on top of the graph can enable real-time updates and historical replay of data amplification. Stated differently, time-series tracking of a multi-node network graph can be implemented by overlaying temporal data onto the existing graph structure, allowing for both real-time monitoring and historical analysis of data flow. In some instances, time-series tracking allows dynamic updates where new data points continuously generate nodes, adjust node attributes (e.g., bot scores), and modify the contextual relationships between nodes, in order to provide immediate insights into system behavior.

For instance, temporal layering can visualize how a particular narrative can be increasingly connected through different user nodes and channel nodes, thus indicating possible cohort formation and abnormal activity patterns. Further, historical replay functionality allows users to review past states of the multi-node network graph, facilitating forensic analysis or trend detection of certain narratives and user cohorts.

In some instances, interactive tools can be incorporated into the network-visualization system 200. The interactive tools can be presented on a graphical user interface of a user device, which facilitate filtering or highlighting of certain nodes of the multi-node network graph based on node attributes (e.g., hide all users except those with high bot scores). Other examples of interactive tools can include features to trace edges between nodes, facilitating understanding of how content elements are connected. In addition to the interactive tools, the network-visualization system 200 can also implement a single visualization or interactive dashboard, which merges multimodal data from multiple platforms, revealing where a particular narrative is being discussed and how it migrates through different communication platforms.

### 6. Other Configurations

Various types of deployments can be considered for implementing the network-visualization system 200. The choice of deployment model affects data processing workflows, storage mechanisms, and accessibility, ensuring that the network-visualization system 200 aligns with the specific requirements of different organizations.

For example, a Software as a Service (SaaS) deployment enables a fully cloud-hosted implementation, in which the network-visualization system 200 operates as a web-accessible application. This configuration leverages cloud computing services such as Amazon Web Services (AWS), Microsoft Azure, or Google Cloud Platform (GCP) to provide on-demand scalability, fault tolerance, and ease of access. Users interact with a web-based dashboard that offers intuitive data visualization, filtering, and analytics capabilities. The SaaS model supports real-time data ingestion through APIs, message queues like Kafka, and event-driven architectures that continuously process incoming content. Security measures include multi-tenant data isolation, role-based access control, and encryption protocols for data in transit and at rest. The SaaS configuration is particularly useful for organizations that require minimal infrastructure management and seamless updates while ensuring compliance with cloud security standards.

In another example, an on-premise deployment provides direct control over infrastructure and data security. This deployment configuration can include installing the network-visualization system 200 within a private data center or an organization's existing IT infrastructure, ensuring compliance with regulatory requirements such as GDPR, HIPAA, or FedRAMP. The network-visualization system 200 can thus operate on dedicated servers or virtualized environments using platforms such as VMware or Kubernetes for container orchestration. Local deployment enables the organization to manage user authentication through existing identity and access management (IAM) solutions such as Active Directory or LDAP. Data processing pipelines utilize in-house computing resources, with NLP models and machine learning algorithms running on dedicated GPU clusters for performance optimization. Security is enhanced through network segmentation, hardware firewalls, and intrusion detection systems to prevent unauthorized access. This deployment configuration is preferred where data sovereignty and confidentiality are critical.

A hybrid deployment balances the benefits of cloud computing with the security of on-premise infrastructure by processing certain data components in the cloud while storing and visualizing sensitive information locally. In this configuration, the network-visualization system 200 utilizes cloud-based services for compute-intensive tasks such as bot scoring and large-scale data classification while maintaining a secure on-premise environment for storing and analyzing sensitive data. For example, raw data ingestion and initial preprocessing might occur in the cloud, leveraging scalable AI models, while other operations are conducted within an organization's private network behind a secure firewall. Secure data transmission protocols such as VPNs or private cloud connections can be implemented to manage flow of communication between cloud and on-premise environments. This configuration is particularly useful for organizations facing mixed-security requirements that need to balance performance with regulatory constraints.

In some instances, the network-visualization system 200 can be configured to operate on distributed infrastructure to support enormous data volumes spanning multiple platforms and languages. In some instances, the network-visualization system can utilize parallel processing to process communication data independently. The network-visualization system 200 can then generate the multi-node network graph using a central process that merges the outputs generated by the distributed systems. For example, computing instances can be invoked to process one or more sets of communication data to generate content elements independently from one another. In some instances, if one or more of the computing instances discover the same or substantially content elements (e.g., by comparing embeddings generated from the corresponding content elements), the merging process can be performed to merge the content elements. In some instances, a computing instance can include a virtual machine (VM), a containerized computing environment, or a cloud instance operating on a remote server. For example, each of the computing instances can be allocated with its own computing resources such as CPU, memory, storage, security configurations, and/or networking resources, such that it can execute a portion of the communication data. The network-visualization system 200 can then process the content elements together to generate the multi-node network graph. In some instances, the network-visualization system 200 can be modularly deployed in separate microservices (e.g., data ingestion, near-duplicate detection, LLM/VLM inference, merging) or in a monolithic design.

### C. Example Implementations

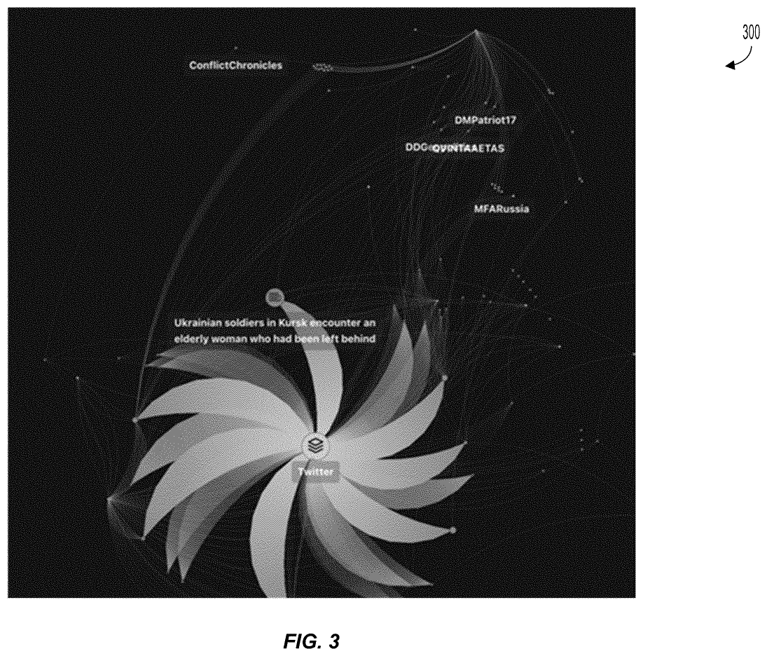

FIG. 3 illustrates an example screenshot of a multi-node network graph 300 representing narratives and communication platforms, according to some embodiments. In this example configuration, nodes in the multi-node network graph 300 represent different content elements of the digital information architecture in one single, dynamic graph structure. As a result, the multi-node network graph 300 enables a holistic view of how social media narratives spread through communication channels and platforms. As shown in FIG. 3, the multi-node network graph 300 includes yellow nodes that represent platforms (e.g., Twitter or Telegram), blue nodes that represent narratives (e.g., “Ukrainian soldiers in Kursk encounter an elderly woman who had been left behind”), and pink nodes that represent channels (e.g., ConflictChronicles). The edges represent where certain narratives originated and propagated through different communication platforms and channels. The multi-node network graph 300 can thus facilitate a deeper understanding of the migration and spread of social media narratives across different platforms, domains, and their constituent channels. As a result, analysts are able to quickly determine which narratives are gaining traction across the full digital information ecosystem.

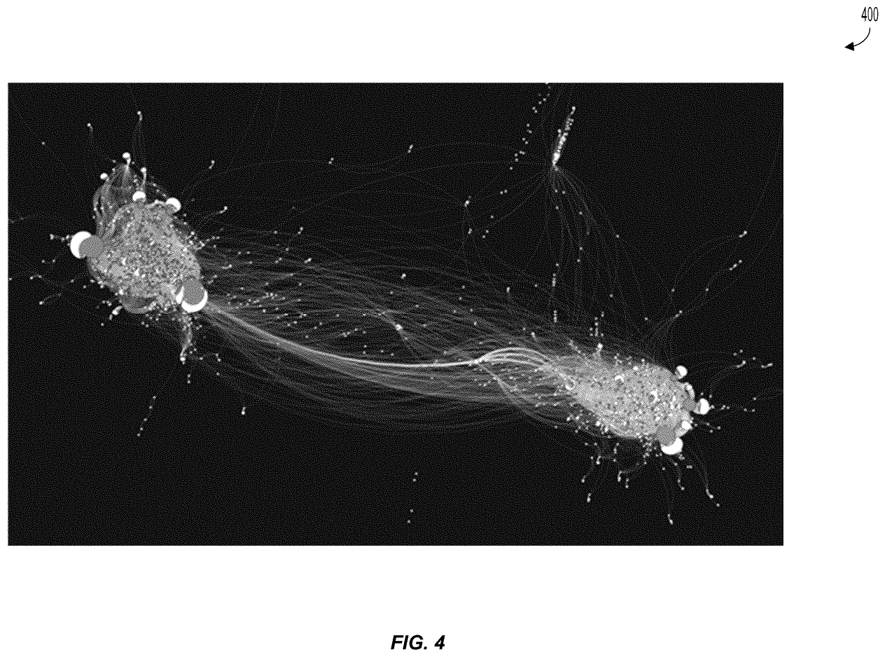

FIG. 4 illustrates an example screenshot of a multi-node network graph 400 representing users and cohorts, according to some embodiments. In this example configuration, nodes in this multi-node network graph 400 represent various social media users and their corresponding cohort classifiers. As described herein, the cohort classifiers can denote different demographic, ideological, or other identity-based actor affiliations. As shown in FIG. 4, the multi-node network graph 400 includes blue nodes that represent Pro-Palestine Cohort users, orange nodes that represent Right-Wing Cohort users, and white nodes that represent all other users. This particular network graph facilitates rapid understanding of relationships between different user demographics, including how communities of like-minded actors interact with each other. The multi-node network graph 400 can also identify how narratives spread and are shaped by the actions and motivations of different user profiles, as well as the impact of social media narratives on certain audiences of interest.

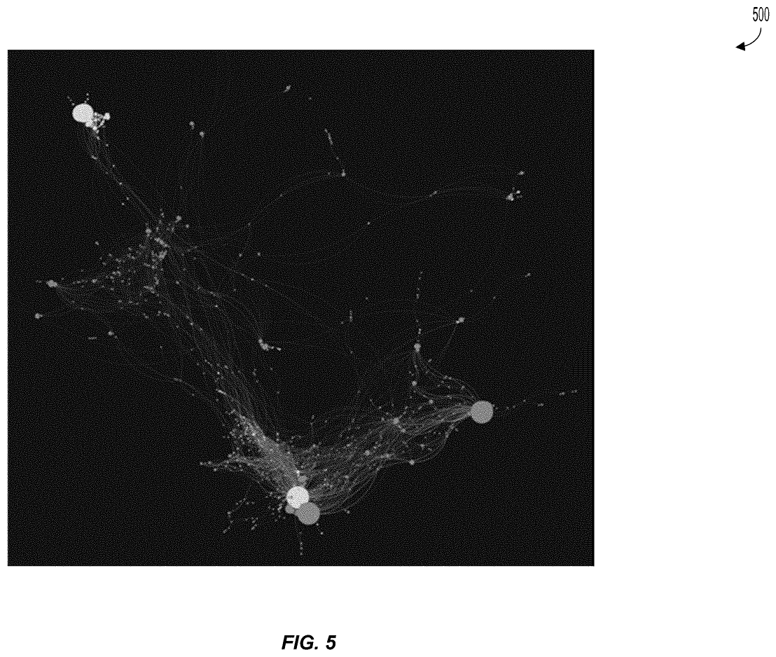

FIG. 5 illustrates an example screenshot of a multi-node network graph 500 representing users, narratives, and entities, according to some embodiments. In this example configuration, the multi-node network graph 500 includes user nodes, entity nodes that identify hashtags and URLs, and narrative nodes that represent social media narratives. The edges can indicate how the entities belong to certain users and narratives. The length of the edges can also indicate how closely certain entities are contextually aligned with a corresponding narrative. As shown in FIG. 5, the multi-node network graph 500 includes green nodes that are associated with a narrative “Calls to bar all Russian athletes from the 2024 Paris Olympics”, purple nodes that are associated with a narrative “Olympian Stephen Van de Velde should be removed from the Dutch national team, due to his criminal history”, and red nodes that are associated with the narrative “The River Seine is too dirty for athletes to swim in during the Olympics.” This particular network graph allows exploration of the contextual relationships between different social media narratives and their constituent entities, including where narratives share common users, hashtags, and shared URLs or where narratives form their own social media echo chambers.

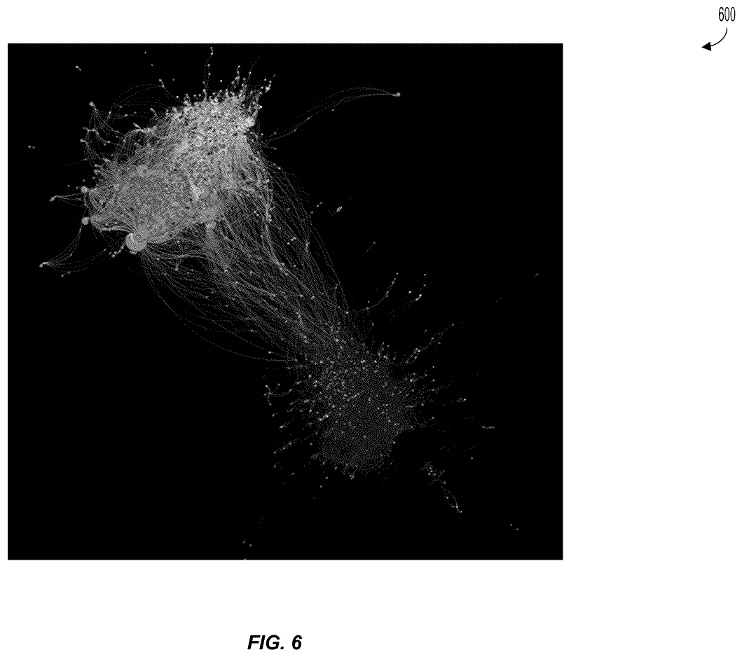

FIG. 6 illustrates an example screenshot of another multi-node network graph 600 representing users and cohorts, according to some embodiments. The coloring in the multi-node network graph 600 highlights three cohorts of content authors: (1) a state actor represented as green nodes; (2) a Domestic Political Party represented as red nodes; and (3) a different Domestic Political Party on the other side represented as blue nodes. Such visualization demonstrates the utility of these visualizations for identifying echo chambers and overlaps between them.

### D. Methods

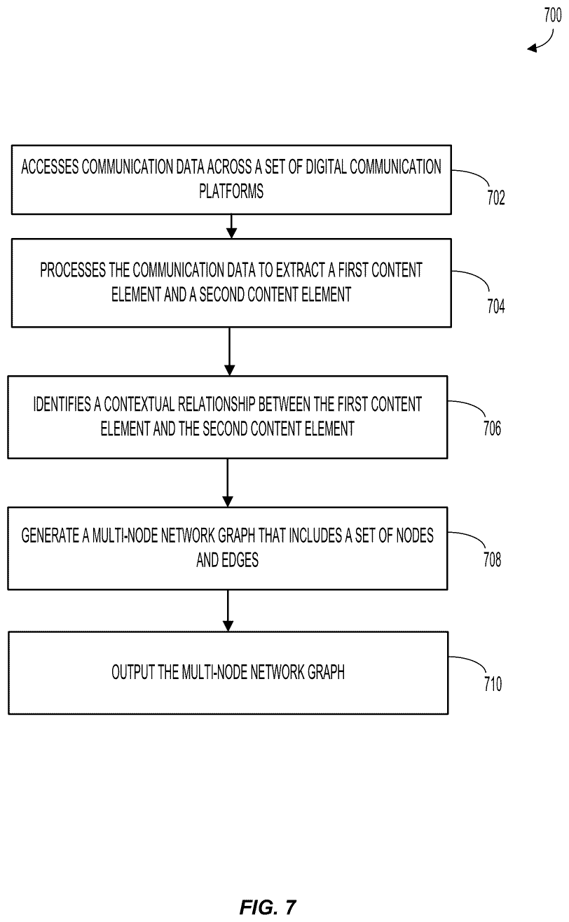

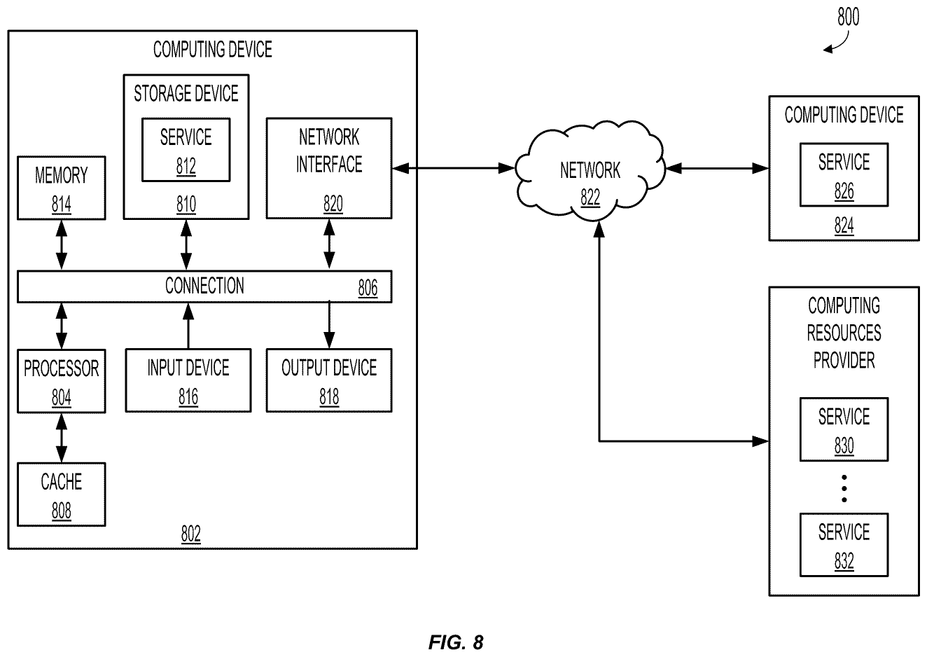

FIG. 7 shows an illustrative example of a process 700 for generating multi-node network graphs representing multi-modal data across multiple digital communication platforms, in accordance with some embodiments. For illustrative purposes, the process 700 is described with reference to the components illustrated in FIGS. 1-6, though other implementations are possible. For example, the program code for the network-visualization system 200 of FIG. 2, is executed by one or more processing devices to cause a server system (e.g., the computing device 802 of FIG. 8) to perform one or more operations described herein.

At step 702, the network-visualization system accesses communication data across a set of digital communication platforms. The digital communication platforms can include social media networks, forums, and news websites. In some instances, the communication data includes structured and unstructured data, such user profiles, posts, comments, timestamps, and associated metadata (e.g., device type, geolocation, platform source) retrieved from one of the social media networks. In some instances, the communication data can be multimodal data that includes combinations of data having multiple data types, such as text, images, audio, video, and sensor readings. In some instances, the multimodal data can also include certain data types such as metadata, document markup language (e.g., JSON), URLs, executable does, and so on.

To standardize this heterogeneous data, the network-visualization system can apply various normalization techniques to the communication data to resolve format inconsistencies, deduplicate records, and align attributes into a common schema. For example, usernames from different communication platforms may be mapped to a single user identity using heuristics or machine-learning-based entity resolution methods. Additionally, the network-visualization system can convert timestamps of the communication from different time zones into a unified format, ensuring consistency across data points when performing time-series analysis. The normalization process facilitates downstream analysis by transforming disparate data representations into a consistent, structured dataset that can be effectively processed for generating the multi-node network graph.

At step 704, the network-visualization system processes the communication data to extract a first content element and a second content element. In some instances, a first content element is associated with a first content type and a second content element is associated with a second content type, in which the first content type is different the second content type. The content type can include one of a user, an entity, a narrative, a communication channel, or a digital-communication platform.

Different techniques can be utilized to identify the narratives or entities representing the communication data. For example, to extract the content elements, the network-visualization system can apply various NER techniques to the communication data to identify people, organizations, locations, and other key entities within the communication data. For example, NER techniques can include the use of machine-learning techniques trained on labeled datasets to recognize entity types based on surrounding words and linguistic structures. Examples of NER techniques can include, but are not limited to, rule-based approaches that rely on predefined dictionaries and regular expressions, statistical models such as Conditional Random Fields (CRF), and deep learning-based methods like Bidirectional LSTMs with CRF layers or transformer-based models such as BERT and spaCy's entity recognition module.

At step 706, the network-visualization system identifies a contextual relationship between the first content element and the second content element. The contextual relationship can include one or more characteristics shared between the first content element and the second content element. In some instances, the contextual relationship identifies how content elements can interact with each other, even if they are directed to different content types and retrieved from various digital communication platforms. The contextual relationships are for illustrative purposes only, and other types of contextual relationships and combinations thereof can be contemplated by a person skilled in the art.

At step 708, the network-visualization system generates a multi-node network graph that includes a set of nodes and edges. In some instances, the set of nodes includes a first node that represents the first content element and a second node that represents the second content element, in which the first node and the second node are connected by a corresponding edge.

The network-visualization system can further generate edges of the multi-node network graph that connect two or more nodes. In some instances, edges capture various types of contextual relationships between the content elements: (i) user-to-narrative (e.g., user posted, shared narrative); (ii) user-to-user (e.g., direct interactions between users); and (iii) user-to-channel (e.g., user posts in that channel). The length of the edges can indicate how closely the two nodes are contextually aligned with each other. For example, edges with shorter distance indicate that an author of a user node published a narrative of a narrative node on several occasions, whereas edges with longer distance may indicate that a second user of a second user node has only shared the narrative of the narrative node once. Alternatively, each edge can represent a single post or document in the system. For instance, a post by User X sharing Narrative Y would generate a single edge between the User X and Narrative Y nodes. In this formulation, there can be multiple edges between a given pair of nodes. When a spatial graph layout algorithm is applied to the visualization network, such as a force-directed graph layout, then nodes with more edges will be positioned closer to one another in space in the graph.

In some instances, the network-visualization system enhances the multi-node network graph by adding various types of enrichment data into the multi-node network graph. For example, the network-visualization system can: (i) generate the enrichment data associated with the first content element and the second content element; and (ii) overlay the enrichment data over the first node and the second node on the multi-node network graph. The enrichment data can be a bot score indicating a likelihood or probability of whether a user associated with the first content element corresponds to an automated agent. In some instances, the enrichment data includes a cohort classifier that classifies the user associated with the first content element as a member of a particular cohort. The enrichment data can also include an anomaly classification indicative of whether the contextual relationship between the first content element and the second content element is associated with a network threat or misinformation.

At step 710, the network-visualization system outputs the multi-node network graph. In some instances, the network-visualization system can generate a plurality of multi-node network graphs over a set of time periods, so as to ascertain how different types of information can propagate across digital-communication platforms over time. For example, for each time period of a set of time periods, the network-visualization system can iterate the steps of accessing, processing, identifying, and generating to generate another multi-node network graph for the time period. The network-visualization system can then generate a time-series visualization of the series of multi-node network graphs across the set of time periods. Process 700 terminates thereafter.

### II. EXAMPLE SYSTEMS

FIG. 8 illustrates a computing system architecture 800, including various components in electrical communication with each other, in accordance with some embodiments. The example computing system architecture 800 illustrated in FIG. 8 includes a computing device 802, which has various components in electrical communication with each other using a connection 806, such as a bus, in accordance with some implementations. The example computing system architecture 800 includes a processing unit 804 that is in electrical communication with various system components, using the connection 806, and including the system memory 814. In some embodiments, the system memory 814 includes read-only memory (ROM), random-access memory (RAM), and other such memory technologies including, but not limited to, those described herein. In some embodiments, the example computing system architecture 800 includes a cache 808 of high-speed memory connected directly with, in close proximity to, or integrated as part of the processor 804. The system architecture 800 can copy data from the memory 814 and/or the storage device 810 to the cache 808 for quick access by the processor 804. In this way, the cache 808 can provide a performance boost that decreases or eliminates processor delays in the processor 804 due to waiting for data. Using modules, methods and services such as those described herein, the processor 804 can be configured to perform various actions. In some embodiments, the cache 808 may include multiple types of cache including, for example, level one (L1) and level two (L2) cache. The memory 814 may be referred to herein as system memory or computer system memory. The memory 814 may include, at various times, elements of an operating system, one or more applications, data associated with the operating system or the one or more applications, or other such data associated with the computing device 802.

Other system memory 814 can be available for use as well. The memory 814 can include multiple different types of memory with different performance characteristics. The processor 804 can include any general purpose processor and one or more hardware or software services, such as service 812 stored in storage device 810, configured to control the processor 804 as well as a special-purpose processor where software instructions are incorporated into the actual processor design. The processor 804 can be a completely self-contained computing system, containing multiple cores or processors, connectors (e.g., buses), memory, memory controllers, caches, etc. In some embodiments, such a self-contained computing system with multiple cores is symmetric. In some embodiments, such a self-contained computing system with multiple cores is asymmetric. In some embodiments, the processor 804 can be a microprocessor, a microcontroller, a digital signal processor (“DSP”), or a combination of these and/or other types of processors. In some embodiments, the processor 804 can include multiple elements such as a core, one or more registers, and one or more processing units such as an arithmetic logic unit (ALU), a floating point unit (FPU), a graphics processing unit (GPU), a physics processing unit (PPU), a digital system processing (DSP) unit, or combinations of these and/or other such processing units.

To enable user interaction with the computing system architecture 800, an input device 816 can represent any number of input mechanisms, such as a microphone for speech, a touch-sensitive screen for gesture or graphical input, keyboard, mouse, motion input, pen, and other such input devices. An output device 818 can also be one or more of a number of output mechanisms known to those of skill in the art including, but not limited to, monitors, speakers, printers, haptic devices, and other such output devices. In some instances, multimodal systems can enable a user to provide multiple types of input to communicate with the computing system architecture 800. In some embodiments, the input device 816 and/or the output device 818 can be coupled to the computing device 802 using a remote connection device such as, for example, a communication interface such as the network interface 820 described herein. In such embodiments, the communication interface can govern and manage the input and output received from the attached input device 816 and/or output device 818. As may be contemplated, there is no restriction on operating on any particular hardware arrangement and accordingly the basic features here may easily be substituted for other hardware, software, or firmware arrangements as they are developed.

In some embodiments, the storage device 810 can be described as non-volatile storage or non-volatile memory. Such non-volatile memory or non-volatile storage can be a hard disk or other types of computer readable media which can store data that are accessible by a computer, such as magnetic cassettes, flash memory cards, solid state memory devices, digital versatile disks, cartridges, RAM, ROM, and hybrids thereof.

As described above, the storage device 810 can include hardware and/or software services such as service 812 that can control or configure the processor 804 to perform one or more functions including, but not limited to, the methods, processes, functions, systems, and services described herein in various embodiments. In some embodiments, the hardware or software services can be implemented as modules. As illustrated in example computing system architecture 800, the storage device 810 can be connected to other parts of the computing device 802 using the system connection 806. In some embodiments, a hardware service or hardware module such as service 812, that performs a function can include a software component stored in a non-transitory computer-readable medium that, in connection with the necessary hardware components, such as the processor 804, connection 806, cache 808, storage device 810, memory 814, input device 816, output device 818, and so forth, can carry out the functions such as those described herein.

The disclosed systems and service of a network-visualization system (e.g., the network-visualization system 200 described herein at least in connection with FIG. 2) can be performed using a computing system such as the example computing system illustrated in FIG. 8, using one or more components of the example computing system architecture 800. An example computing system can include a processor (e.g., a central processing unit), memory, non-volatile memory, and an interface device. The memory may store data and/or and one or more code sets, software, scripts, etc. The components of the computer system can be coupled together via a bus or through some other known or convenient device.

In some embodiments, the processor can be configured to carry out some or all of methods and systems for generating multi-node network graphs associated with the network-visualization system (e.g., network-visualization system 200 described herein at least in connection with FIG. 2) described herein by, for example, executing code using a processor such as processor 804 wherein the code is stored in memory such as memory 814 as described herein. One or more of a user device, a provider server or system, a database system, or other such devices, services, or systems may include some or all of the components of the computing system such as the example computing system illustrated in FIG. 8, using one or more components of the example computing system architecture 800 illustrated herein. As may be contemplated, variations on such systems can be considered as within the scope of the present disclosure.

This disclosure contemplates the computer system taking any suitable physical form. As example and not by way of limitation, the computer system can be an embedded computer system, a system-on-chip (SOC), a single-board computer system (SBC) (such as, for example, a computer-on-module (COM) or system-on-module (SOM)), a desktop computer system, a laptop or notebook computer system, a tablet computer system, a wearable computer system or interface, an interactive kiosk, a mainframe, a mesh of computer systems, a mobile telephone, a personal digital assistant (PDA), a server, or a combination of two or more of these. Where appropriate, the computer system may include one or more computer systems; be unitary or distributed; span multiple locations; span multiple machines; and/or reside in a cloud computing system which may include one or more cloud components in one or more networks as described herein in association with the computing resources provider 828. Where appropriate, one or more computer systems may perform without substantial spatial or temporal limitation one or more steps of one or more methods described or illustrated herein. As an example and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

The processor 804 can be a conventional microprocessor such as an Intel® microprocessor, an AMD® microprocessor, a Motorola® microprocessor, or other such microprocessors. One of skill in the relevant art will recognize that the terms “machine-readable (storage) medium” or “computer-readable (storage) medium” include any type of device that is accessible by the processor.

The memory 814 can be coupled to the processor 804 by, for example, a connector such as connector 806, or a bus. As used herein, a connector or bus such as connector 806 is a communications system that transfers data between components within the computing device 802 and may, in some embodiments, be used to transfer data between computing devices. The connector 806 can be a data bus, a memory bus, a system bus, or other such data transfer mechanism. Examples of such connectors include, but are not limited to, an industry standard architecture (ISA″ bus, an extended ISA (EISA) bus, a parallel AT attachment (PATA″ bus (e.g., an integrated drive electronics (IDE) or an extended IDE (EIDE) bus), or the various types of parallel component interconnect (PCI) buses (e.g., PCI, PCIe, PCI-104, etc.).

The memory 814 can include RAM including, but not limited to, dynamic RAM (DRAM), static RAM (SRAM), synchronous dynamic RAM (SDRAM), non-volatile random access memory (NVRAM), and other types of RAM. The DRAM may include error-correcting code (EEC). The memory can also include ROM including, but not limited to, programmable ROM (PROM), erasable and programmable ROM (EPROM), electronically erasable and programmable ROM (EEPROM), Flash Memory, masked ROM (MROM), and other types or ROM. The memory 814 can also include magnetic or optical data storage media including read-only (e.g., CD ROM and DVD ROM) or otherwise (e.g., CD or DVD). The memory can be local, remote, or distributed.

As described above, the connector 806 (or bus) can also couple the processor 804 to the storage device 810, which may include non-volatile memory or storage and which may also include a drive unit. In some embodiments, the non-volatile memory or storage is a magnetic floppy or hard disk, a magnetic-optical disk, an optical disk, a ROM (e.g., a CD-ROM, DVD-ROM, EPROM, or EEPROM), a magnetic or optical card, or another form of storage for data. Some of this data may be written, by a direct memory access process, into memory during execution of software in a computer system. The non-volatile memory or storage can be local, remote, or distributed. In some embodiments, the non-volatile memory or storage is optional. As may be contemplated, a computing system can be created with all applicable data available in memory. A typical computer system will usually include at least one processor, memory, and a device (e.g., a bus) coupling the memory to the processor.

Software and/or data associated with software can be stored in the non-volatile memory and/or the drive unit. In some embodiments (e.g., for large programs) it may not be possible to store the entire program and/or data in the memory at any one time. In such embodiments, the program and/or data can be moved in and out of memory from, for example, an additional storage device such as storage device 810. Nevertheless, it should be understood that for software to run, if necessary, it is moved to a computer readable location appropriate for processing, and for illustrative purposes, that location is referred to as the memory herein. Even when software is moved to the memory for execution, the processor can make use of hardware registers to store values associated with the software, and local cache that, ideally, serves to speed up execution. As used herein, a software program is assumed to be stored at any known or convenient location (from non-volatile storage to hardware registers), when the software program is referred to as “implemented in a computer-readable medium.” A processor is considered to be “configured to execute a program” when at least one value associated with the program is stored in a register readable by the processor.

The connection 806 can also couple the processor 804 to a network interface device such as the network interface 820. The interface can include one or more of a modem or other such network interfaces including, but not limited to those described herein. It will be appreciated that the network interface 820 may be considered to be part of the computing device 802 or may be separate from the computing device 802. The network interface 820 can include one or more of an analog modem, Integrated Services Digital Network (ISDN) modem, cable modem, token ring interface, satellite transmission interface, or other interfaces for coupling a computer system to other computer systems. In some embodiments, the network interface 820 can include one or more input and/or output (I/O) devices. The I/O devices can include, by way of example but not limitation, input devices such as input device 816 and/or output devices such as output device 818. For example, the network interface 820 may include a keyboard, a mouse, a printer, a scanner, a display device, and other such components. Other examples of input devices and output devices are described herein. In some embodiments, a communication interface device can be implemented as a complete and separate computing device.

In operation, the computer system can be controlled by operating system software that includes a file management system, such as a disk operating system. One example of operating system software with associated file management system software is the family of Windows® operating systems and their associated file management systems. Another example of operating system software with its associated file management system software is the Linux™ operating system and its associated file management system including, but not limited to, the various types and implementations of the Linux® operating system and their associated file management systems. The file management system can be stored in the non-volatile memory and/or drive unit and can cause the processor to execute the various acts required by the operating system to input and output data and to store data in the memory, including storing files on the non-volatile memory and/or drive unit. As may be contemplated, other types of operating systems such as, for example, MacOS®, other types of UNIX® operating systems (e.g., BSD™ and descendants, Xenix™, SunOS™, HP-UX®, etc.), mobile operating systems (e.g., iOS® and variants, Chrome®, Ubuntu Touch®, watchOS®, Windows 10 Mobile®, the Blackberry® OS, etc.), and real-time operating systems (e.g., VxWorks®, QNX®, eCos®, RTLinux®, etc.) may be considered as within the scope of the present disclosure. As may be contemplated, the names of operating systems, mobile operating systems, real-time operating systems, languages, and devices, listed herein may be registered trademarks, service marks, or designs of various associated entities.

In some embodiments, the computing device 802 can be connected to one or more additional computing devices such as computing device 824 via a network 822 using a connection such as the network interface 820. In such embodiments, the computing device 824 may execute one or more services 826 to perform one or more functions under the control of, or on behalf of, programs and/or services operating on computing device 802. In some embodiments, a computing device such as computing device 824 may include one or more of the types of components as described in connection with computing device 802 including, but not limited to, a processor such as processor 804, a connection such as connection 806, a cache such as cache 808, a storage device such as storage device 810, memory such as memory 814, an input device such as input device 816, and an output device such as output device 818. In such embodiments, the computing device 824 can carry out the functions such as those described herein in connection with computing device 802. In some embodiments, the computing device 802 can be connected to a plurality of computing devices such as computing device 824, each of which may also be connected to a plurality of computing devices such as computing device 824. Such an embodiment may be referred to herein as a distributed computing environment.

The network 822 can be any network including an internet, an intranet, an extranet, a cellular network, a Wi-Fi network, a local area network (LAN), a wide area network (WAN), a satellite network, a Bluetooth® network, a virtual private network (VPN), a public switched telephone network, an infrared (IR) network, an internet of things (IoT network) or any other such network or combination of networks. Communications via the network 822 can be wired connections, wireless connections, or combinations thereof. Communications via the network 822 can be made via a variety of communications protocols including, but not limited to, Transmission Control Protocol/Internet Protocol (TCP/IP), User Datagram Protocol (UDP), protocols in various layers of the Open System Interconnection (OSI) model, File Transfer Protocol (FTP), Universal Plug and Play (UPnP), Network File System (NFS), Server Message Block (SMB), Common Internet File System (CIFS), and other such communications protocols.

Communications over the network 822, within the computing device 802, within the computing device 824, or within the computing resources provider 828 can include information, which also may be referred to herein as content. The information may include text, graphics, audio, video, haptics, and/or any other information that can be provided to a user of the computing device such as the computing device 802. In some embodiments, the information can be delivered using a transfer protocol such as Hypertext Markup Language (HTML), Extensible Markup Language (XML), JavaScript®, Cascading Style Sheets (CSS), JavaScript® Object Notation (JSON), and other such protocols and/or structured languages. The information may first be processed by the computing device 802 and presented to a user of the computing device 802 using forms that are perceptible via sight, sound, smell, taste, touch, or other such mechanisms. In some embodiments, communications over the network 822 can be received and/or processed by a computing device configured as a server. Such communications can be sent and received using PHP: Hypertext Preprocessor (“PHP”), Python™, Ruby, Perl® and variants, Java®, HTML, XML, or another such server-side processing language.

In some embodiments, the computing device 802 and/or the computing device 824 can be connected to a computing resources provider 828 via the network 822 using a network interface such as those described herein (e.g. network interface 820). In such embodiments, one or more systems (e.g., service 830 and service 832) hosted within the computing resources provider 828 (also referred to herein as within “a computing resources provider environment”) may execute one or more services to perform one or more functions under the control of, or on behalf of, programs and/or services operating on computing device 802 and/or computing device 824. Systems such as service 830 and service 832 may include one or more computing devices such as those described herein to execute computer code to perform the one or more functions under the control of, or on behalf of, programs and/or services operating on computing device 802 and/or computing device 824.

For example, the computing resources provider 828 may provide a service, operating on service 830 to store data for the computing device 802 when, for example, the amount of data that the computing device 802 exceeds the capacity of storage device 810. In another example, the computing resources provider 828 may provide a service to first instantiate a virtual machine (VM) on service 832, use that VM to access the data stored on service 832, perform one or more operations on that data, and provide a result of those one or more operations to the computing device 802. Such operations (e.g., data storage and VM instantiation) may be referred to herein as operating “in the cloud,” “within a cloud computing environment,” or “within a hosted virtual machine environment,” and the computing resources provider 828 may also be referred to herein as “the cloud.” Examples of such computing resources providers include, but are not limited to Amazon® Web Services (AWS®), Microsoft's Azure®, IBM Cloud®, Google Cloud®, Oracle Cloud® etc.

Services provided by a computing resources provider 828 include, but are not limited to, data analytics, data storage, archival storage, big data storage, virtual computing (including various scalable VM architectures), blockchain services, containers (e.g., application encapsulation), database services, development environments (including sandbox development environments), e-commerce solutions, game services, media and content management services, security services, server-less hosting, virtual reality (VR) systems, and augmented reality (AR) systems. Various techniques to facilitate such services include, but are not be limited to, virtual machines, virtual storage, database services, system schedulers (e.g., hypervisors), resource management systems, various types of short-term, mid-term, long-term, and archival storage devices, etc.

As may be contemplated, the systems such as service 830 and service 832 may implement versions of various services (e.g., the service 812 or the service 826) on behalf of, or under the control of, computing device 802 and/or computing device 824. Such implemented versions of various services may involve one or more virtualization techniques so that, for example, it may appear to a user of computing device 802 that the service 812 is executing on the computing device 802 when the service is executing on, for example, service 830. As may also be contemplated, the various services operating within the computing resources provider 828 environment may be distributed among various systems within the environment as well as partially distributed onto computing device 824 and/or computing device 802.

Client devices, user devices, computer resources provider devices, network devices, and other devices can be computing systems that include one or more integrated circuits, input devices, output devices, data storage devices, and/or network interfaces, among other things. The integrated circuits can include, for example, one or more processors, volatile memory, and/or non-volatile memory, among other things such as those described herein. The input devices can include, for example, a keyboard, a mouse, a key pad, a touch interface, a microphone, a camera, and/or other types of input devices including, but not limited to, those described herein. The output devices can include, for example, a display screen, a speaker, a haptic feedback system, a printer, and/or other types of output devices including, but not limited to, those described herein. A data storage device, such as a hard drive or flash memory, can enable the computing device to temporarily or permanently store data. A network interface, such as a wireless or wired interface, can enable the computing device to communicate with a network. Examples of computing devices (e.g., the computing device 802) include, but is not limited to, desktop computers, laptop computers, server computers, hand-held computers, tablets, smart phones, personal digital assistants, digital home assistants, wearable devices, smart devices, and combinations of these and/or other such computing devices as well as machines and apparatuses in which a computing device has been incorporated and/or virtually implemented.

The techniques described herein may also be implemented in electronic hardware, computer software, firmware, or any combination thereof. Such techniques may be implemented in any of a variety of devices such as general purpose computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as that described herein. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices (e.g., a combination of a DSP and a microprocessor), a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for implementing a suspended database update system.

As used herein, the term “machine-readable media” and equivalent terms “machine-readable storage media,” “computer-readable media,” and “computer-readable storage media” refer to media that includes, but is not limited to, portable or non-portable storage devices, optical storage devices, removable or non-removable storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), solid state drives (SSD), flash memory, memory or memory devices.

A machine-readable medium or machine-readable storage medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like. Further examples of machine-readable storage media, machine-readable media, or computer-readable (storage) media include but are not limited to recordable type media such as volatile and non-volatile memory devices, floppy and other removable disks, hard disk drives, optical disks (e.g., CDs, DVDs, etc.), among others, and transmission type media such as digital and analog communication links.

As may be contemplated, while examples herein may illustrate or refer to a machine-readable medium or machine-readable storage medium as a single medium, the term “machine-readable medium” and “machine-readable storage medium” should be taken to include a single medium or multiple media (e.g., a centralized or distributed database, and/or associated caches and servers) that store the one or more sets of instructions. The term “machine-readable medium” and “machine-readable storage medium” shall also be taken to include any medium that is capable of storing, encoding, or carrying a set of instructions for execution by the system and that cause the system to perform any one or more of the methodologies or modules of disclosed herein.

Some portions of the detailed description herein may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like, refer to the action and processes of a computer system, or similar electronic computing device, that manipulates and transforms data represented as physical (electronic) quantities within registers and memories of the computer system into other data similarly represented as physical quantities within the computer system memories or registers or other such information storage, transmission or display devices.

It is also noted that individual implementations may be described as a process which is depicted as a flowchart, a flow diagram, a data flow diagram, a structure diagram, or a block diagram (e.g., the example process 700 of FIG. 7). Although a flowchart, a flow diagram, a data flow diagram, a structure diagram, or a block diagram may describe the operations as a sequential process, many of the operations can be performed in parallel or concurrently. In addition, the order of the operations may be re-arranged. A process illustrated in a figure is terminated when its operations are completed, but could have additional steps not included in the figure. A process may correspond to a method, a function, a procedure, a subroutine, a subprogram, etc. When a process corresponds to a function, its termination can correspond to a return of the function to the calling function or the main function.

In some embodiments, one or more implementations of an algorithm such as those described herein may be implemented using a machine learning or artificial intelligence algorithm. Such a machine learning or artificial intelligence algorithm may be trained using supervised, unsupervised, reinforcement, or other such training techniques. For example, a set of data may be analyzed using one of a variety of machine learning algorithms to identify correlations between different elements of the set of data without supervision and feedback (e.g., an unsupervised training technique). A machine learning data analysis algorithm may also be trained using sample or live data to identify potential correlations. Such algorithms may include k-means clustering algorithms, fuzzy c-means (FCM) algorithms, expectation-maximization (EM) algorithms, hierarchical clustering algorithms, density-based spatial clustering of applications with noise (DBSCAN) algorithms, and the like. Other examples of machine learning or artificial intelligence algorithms include, but are not limited to, genetic algorithms, backpropagation, reinforcement learning, decision trees, linear classification, artificial neural networks, anomaly detection, and such. More generally, machine learning or artificial intelligence methods may include regression analysis, dimensionality reduction, metalearning, reinforcement learning, deep learning, and other such algorithms and/or methods. As may be contemplated, the terms “machine learning” and “artificial intelligence” are frequently used interchangeably due to the degree of overlap between these fields and many of the disclosed techniques and algorithms have similar approaches.

As an example of a supervised training technique, a set of data can be selected for training of the machine learning model to facilitate identification of correlations between members of the set of data. The machine learning model may be evaluated to determine, based on the sample inputs supplied to the machine learning model, whether the machine learning model is producing accurate correlations between members of the set of data. Based on this evaluation, the machine learning model may be modified to increase the likelihood of the machine learning model identifying the desired correlations. The machine learning model may further be dynamically trained by soliciting feedback from users of a system as to the efficacy of correlations provided by the machine learning algorithm or artificial intelligence algorithm (i.e., the supervision). The machine learning algorithm or artificial intelligence may use this feedback to improve the algorithm for generating correlations (e.g., the feedback may be used to further train the machine learning algorithm or artificial intelligence to provide more accurate correlations).

The various examples of flowcharts, flow diagrams, data flow diagrams, structure diagrams, or block diagrams discussed herein may further be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable storage medium (e.g., a medium for storing program code or code segments) such as those described herein. A processor(s), implemented in an integrated circuit, may perform the necessary tasks.

The various illustrative logical blocks, modules, circuits, and algorithm steps described in connection with the implementations disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

It should be noted, however, that the algorithms and displays presented herein are not inherently related to any particular computer or other apparatus. Various general purpose systems may be used with programs in accordance with the teachings herein, or it may prove convenient to construct more specialized apparatus to perform the methods of some examples. The required structure for a variety of these systems will appear from the description below. In addition, the techniques are not described with reference to any particular programming language, and various examples may thus be implemented using a variety of programming languages.

In various implementations, the system operates as a standalone device or may be connected (e.g., networked) to other systems. In a networked deployment, the system may operate in the capacity of a server or a client system in a client-server network environment, or as a peer system in a peer-to-peer (or distributed) network environment.

The system may be a server computer, a client computer, a personal computer (PC), a tablet PC (e.g., an iPad®, a Microsoft Surface®, a Chromebook®, etc.), a laptop computer, a set-top box (STB), a personal digital assistants (PDA), a mobile device (e.g., a cellular telephone, an iPhone®, and Android® device, a Blackberry®, etc.), a wearable device, an embedded computer system, an electronic book reader, a processor, a telephone, a web appliance, a network router, switch or bridge, or any system capable of executing a set of instructions (sequential or otherwise) that specify actions to be taken by that system. The system may also be a virtual system such as a virtual version of one of the aforementioned devices that may be hosted on another computer device such as the computer device 802.

In general, the routines executed to implement the implementations of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while examples have been described in the context of fully functioning computers and computer systems, those skilled in the art will appreciate that the various examples are capable of being distributed as a program object in a variety of forms, and that the disclosure applies equally regardless of the particular type of machine or computer-readable media used to actually effect the distribution.

In some circumstances, operation of a memory device, such as a change in state from a binary one to a binary zero or vice-versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous or vice versa. The foregoing is not intended to be an exhaustive list of all examples in which a change in state for a binary one to a binary zero or vice-versa in a memory device may comprise a transformation, such as a physical transformation. Rather, the foregoing is intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting or restricting the subject matter to the precise forms disclosed. Persons skilled in the relevant art can appreciate that many modifications and variations are possible in light of the above disclosure and may be made thereto without departing from the broader scope of the embodiments as set forth herein. Numerous specific details are described to provide a thorough understanding of the disclosure. However, in certain instances, well-known or conventional details are not described in order to avoid obscuring the description.

As used herein, the terms “connected,” “coupled,” or any variant thereof when applying to modules of a system, means any connection or coupling, either direct or indirect, between two or more elements; the coupling of connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, or any combination of the items in the list.

As used herein, the terms “a” and “an” and “the” and other such singular referents are to be construed to include both the singular and the plural, unless otherwise indicated herein or clearly contradicted by context.

As used herein, the terms “comprising,” “having,” “including,” and “containing” are to be construed as open-ended (e.g., “including” is to be construed as “including, but not limited to”), unless otherwise indicated or clearly contradicted by context.

As used herein, the recitation of ranges of values is intended to serve as a shorthand method of referring individually to each separate value falling within the range, unless otherwise indicated or clearly contradicted by context. Accordingly, each separate value of the range is incorporated into the specification as if it were individually recited herein.

As used herein, use of the terms “set” (e.g., “a set of items”) and “subset” (e.g., “a subset of the set of items”) is to be construed as a nonempty collection including one or more members unless otherwise indicated or clearly contradicted by context. Furthermore, unless otherwise indicated or clearly contradicted by context, the term “subset” of a corresponding set does not necessarily denote a proper subset of the corresponding set but that the subset and the set may include the same elements (i.e., the set and the subset may be the same).

As used herein, use of conjunctive language such as “at least one of A, B, and C” is to be construed as indicating one or more of A, B, and C (e.g., any one of the following nonempty subsets of the set {A, B, C}, namely: {A}, {B}, {C}, {A, B}, {A, C}, {B, C}, or {A, B, C}) unless otherwise indicated or clearly contradicted by context. Accordingly, conjunctive language such as “as least one of A, B, and C” does not imply a requirement for at least one of A, at least one of B, and at least one of C.

As used herein, the use of examples or exemplary language (e.g., “such as” or “as an example”) is intended to more clearly illustrate embodiments and does not impose a limitation on the scope unless otherwise claimed. Such language in the specification should not be construed as indicating any non-claimed element is required for the practice of the embodiments described and claimed in the present disclosure.

As used herein, where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

Those of skill in the art will appreciate that the disclosed subject matter may be embodied in other forms and manners not shown below. It is understood that the use of relational terms, if any, such as first, second, top and bottom, and the like are used solely for distinguishing one entity or action from another, without necessarily requiring or implying any such actual relationship or order between such entities or actions.

While processes or blocks are presented in a given order, alternative implementations may perform routines having steps, or employ systems having blocks, in a different order, and some processes or blocks may be deleted, moved, added, subdivided, substituted, combined, and/or modified to provide alternative or sub combinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various examples described above can be combined to provide further examples.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further examples of the disclosure.

These and other changes can be made to the disclosure in light of the above Detailed Description. While the above description describes certain examples, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific implementations disclosed in the specification, unless the above Detailed Description section explicitly defines such terms. Accordingly, the actual scope of the disclosure encompasses not only the disclosed implementations, but also all equivalent ways of practicing or implementing the disclosure under the claims.

While certain aspects of the disclosure are presented below in certain claim forms, the inventors contemplate the various aspects of the disclosure in any number of claim forms. Any claims intended to be treated under 45 U.S.C. § 112(f) will begin with the words “means for”. Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics, and/or quotation marks. The use of highlighting has no influence on the scope and meaning of a term; the scope and meaning of a term is the same, in the same context, whether or not it is highlighted. It will be appreciated that the same element can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various examples given in this specification.

Without intent to further limit the scope of the disclosure, examples of instruments, apparatus, methods and their related results according to the examples of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

Some portions of this description describe examples in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In some examples, a software module is implemented with a computer program object comprising a computer-readable medium containing computer program code, which can be executed by a computer processor for performing any or all of the steps, operations, or processes described.

Examples may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Examples may also relate to an object that is produced by a computing process described herein. Such an object may comprise information resulting from a computing process, where the information is stored on a non-transitory, tangible computer readable storage medium and may include any implementation of a computer program object or other data combination described herein.

The language used in the specification has been principally selected for readability and instructional purposes, and it may not have been selected to delineate or circumscribe the subject matter. It is therefore intended that the scope of this disclosure be limited not by this detailed description, but rather by any claims that issue on an application based hereon. Accordingly, the disclosure of the examples is intended to be illustrative, but not limiting, of the scope of the subject matter, which is set forth in the following claims.

Specific details were given in the preceding description to provide a thorough understanding of various implementations of systems and components for a contextual connection system. It will be understood by one of ordinary skill in the art, however, that the implementations described above may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A computer-implemented method comprising:
accessing communication data across a set of digital communication platforms, wherein the communication data includes multimodal data;
processing the communication data to extract a first content element and a second content element, wherein a first content element is associated with a first content type and a second content element is associated with a second content type, wherein the first content type is different the second content type;
identifying a contextual relationship between the first content element and the second content element, wherein the contextual relationship includes one or more characteristics shared between the first content element and the second content element;
generating a multi-node network graph that includes a set of nodes and edges, wherein the set of nodes includes a first node that represents the first content element and a second node that represents the second content element, and wherein the first node and the second node are connected by a corresponding edge; and
outputting the multi-node network graph.

2. The computer-implemented method of claim 1, further comprising:
generating enrichment data associated with the first content element and the second content element; and
overlaying the enrichment data over the first node and the second node on the multi-node network graph.

3. The computer-implemented method of claim 2, wherein the enrichment data includes a bot score indicating a likelihood or probability of whether a user associated with the first content element corresponds to an automated agent.

4. The computer-implemented method of claim 2, wherein the enrichment data includes a cohort classifier that classifies a user associated with the first content element as a member of a particular cohort.

5. The computer-implemented method of claim 2, wherein the enrichment data includes an anomaly classification indicative of whether the contextual relationship between the first content element and the second content element is associated with a network threat or misinformation.

6. The computer-implemented method of claim 1, wherein the multi-node network graph corresponds to a particular time period, the computer-implemented method further comprising:
generating a series of multi-node network graphs across a set of time periods, wherein the series of multi-node network graphs includes the multi-node network graph, and wherein generating the series of multi-node network graphs further includes, for each time period of a set of time periods:
iterating steps of accessing, processing, identifying, and generating to generate another multi-node network graph for the time period; and
generating a time-series visualization of the series of multi-node network graphs across the set of time periods.

7. The computer-implemented method of claim 1, wherein the first content type includes one of a user, an entity, a narrative, a communication channel, or a digital-communication platform.

8. A system comprising:
one or more processors; and
memory storing thereon instructions that, as a result of being executed by the one or more processors, cause the system to perform operations comprising:
accessing communication data across a set of digital communication platforms, wherein the communication data includes multimodal data;
processing the communication data to extract a first content element and a second content element, wherein a first content element is associated with a first content type and a second content element is associated with a second content type, wherein the first content type is different the second content type;
identifying a contextual relationship between the first content element and the second content element, wherein the contextual relationship includes one or more characteristics shared between the first content element and the second content element;
generating a multi-node network graph that includes a set of nodes and edges, wherein the set of nodes includes a first node that represents the first content element and a second node that represents the second content element, and wherein the first node and the second node are connected by a corresponding edge; and
outputting the multi-node network graph.

9. The system of claim 8, wherein the instructions further cause the system to perform operations comprising:
generating enrichment data associated with the first content element and the second content element; and
overlaying the enrichment data over the first node and the second node on the multi-node network graph.

10. The system of claim 9, wherein the enrichment data includes a bot score indicating a likelihood or probability of whether a user associated with the first content element corresponds to an automated agent.

11. The system of claim 9, wherein the enrichment data includes a cohort classifier that classifies a user associated with the first content element as a member of a particular cohort.

12. The system of claim 9, wherein the enrichment data includes an anomaly classification indicative of whether the contextual relationship between the first content element and the second content element is associated with a network threat or misinformation.

13. The system of claim 8, wherein the multi-node network graph corresponds to a particular time period, wherein the instructions further cause the system to perform operations comprising:
generating a series of multi-node network graphs across a set of time periods, wherein the series of multi-node network graphs includes the multi-node network graph, and wherein generating the series of multi-node network graphs further includes, for each time period of a set of time periods:
iterating steps of accessing, processing, identifying, and generating to generate another multi-node network graph for the time period; and
generating a time-series visualization of the series of multi-node network graphs across the set of time periods.

14. The system of claim 8, wherein the first content type includes one of a user, an entity, a narrative, a communication channel, or a digital-communication platform.

15. A non-transitory, computer-readable storage medium storing thereon executable instructions that, as a result of being executed by one or more processors of a computer system, cause the computer system to perform operations comprising:
accessing communication data across a set of digital communication platforms, wherein the communication data includes multimodal data;
processing the communication data to extract a first content element and a second content element, wherein a first content element is associated with a first content type and a second content element is associated with a second content type, wherein the first content type is different the second content type;
identifying a contextual relationship between the first content element and the second content element, wherein the contextual relationship includes one or more characteristics shared between the first content element and the second content element;
generating a multi-node network graph that includes a set of nodes and edges, wherein the set of nodes includes a first node that represents the first content element and a second node that represents the second content element, and wherein the first node and the second node are connected by a corresponding edge; and
outputting the multi-node network graph.

16. The non-transitory, computer-readable storage medium of claim 15, wherein the instructions further cause the computer system to perform operations comprising:
generating enrichment data associated with the first content element and the second content element; and
overlaying the enrichment data over the first node and the second node on the multi-node network graph.

17. The non-transitory, computer-readable storage medium of claim 16, wherein the enrichment data includes a bot score indicating a likelihood or probability of whether a user associated with the first content element corresponds to an automated agent.

18. The non-transitory, computer-readable storage medium of claim 16, wherein the enrichment data includes a cohort classifier that classifies a user associated with the first content element as a member of a particular cohort.

19. The non-transitory, computer-readable storage medium of claim 16, wherein the enrichment data includes an anomaly classification indicative of whether the contextual relationship between the first content element and the second content element is associated with a network threat or misinformation.

20. The non-transitory, computer-readable storage medium of claim 15, wherein the multi-node network graph corresponds to a particular time period, wherein the instructions further cause the computer system to perform operations comprising:
generating a series of multi-node network graphs across a set of time periods, wherein the series of multi-node network graphs includes the multi-node network graph, and wherein generating the series of multi-node network graphs further includes, for each time period of a set of time periods:
iterating steps of accessing, processing, identifying, and generating to generate another multi-node network graph for the time period; and
generating a time-series visualization of the series of multi-node network graphs across the set of time periods.

21. The non-transitory, computer-readable storage medium of claim 15, wherein the first content type includes one of a user, an entity, a narrative, a communication channel, or a digital-communication platform.
